(19) United States
(12) Patent Application Publication
(10) Pub. No.: US 2005/0228553 A1
(43) Pub. Date: Oct. 13, 2005

(54) Hybrid Electric Vehicle Energy Management System

(75) Inventor: Bruce W. Tryon, West Bloomfield, MI (US)

Correspondence Address: RAGGIO & DINNIN, P.C., 2701 CAMBRIDGE COURT, STE. 410, AUBURN HILLS, MI, 48326, US

(73) Assignee: WILLIAMS INTERNATIONAL CO., L.L.C., Walled Lake, MI (US)

(21) Appl. No.: 10/708,897

(22) Filed: Mar. 30, 2004

(51) Int. Cl. B60K 6/02

(52) U.S. Cl. 701/22; 180/6.5

(57) ABSTRACT

A vehicle location sensor such as a GPS, an inertial navigation or dead reckoning system determines location data for a vehicle that travels from a known first destination to a second destination. This location data is processed by a route computer system, and associated vehicle driving patterns are stored in memory. Measured vehicle locations, possibly in combination with stored driving pattern information, are used to anticipate a likely second destination and a likely associated driving pattern from a current location of the vehicle to the likely second destination. The anticipation of a destination or a driving pattern can be responsive to associated likelihoods based upon previous vehicle behavior, which likelihoods can be also dependent upon the time of day, day of week or date. A power generator and an energy storage device of a hybrid electric vehicle are controlled responsive to the anticipated likely driving pattern, and possibly responsive to information from environment sensors. In one embodiment, a recuperated turbine engine power generator is shut off in advance of reaching an anticipated destination so as to recover latent heat energy from a regenerator, wherein the recovered energy can be either stored in the energy storage unit or used to drive a traction motor of the hybrid electric vehicle.

### BRIEF DESCRIPTION OF DRAWINGS

In the accompanying drawings:

FIG. 1 illustrates a block diagram of a hybrid vehicle system incorporating an energy management system;

FIG. 2 illustrates a turbine power generator;

FIG. 3 illustrates an internal combustion engine power generator;

FIG. 4 illustrates a portion of a map containing various road segments, intersections, destinations and destination circles;

FIG. 5 illustrates a data structure that provides for relating location coordinates to associated road lists, destination circle lists and intersection lists;

FIG. 6a illustrates a data structure for a road list that is linked to the data structure of FIG. 5;

FIG. 6b illustrates a data structure for road property data that is linked to the data structure of FIG. 6a;

FIG. 7a illustrates a data structure for a destination circle list that is linked to the data structure of FIG. 5;

FIG. 7b illustrates a data structure for destination circle data that is referenced by the data structure of FIG. 7a;

FIG. 7c illustrates a data structure listing the destinations that are associated with a particular destination circle, linked to the data structure of FIG. 7b;

FIG. 7d illustrates a data structure listing the properties of each destination that is referenced by the data structure of FIG. 7c;

FIG. 8a illustrates a data structure for an intersection list that is linked to the data structure of FIG. 5;

FIG. 8b illustrates a data structure for intersection data that is referenced by the data structure of FIG. 8a;

FIG. 8c illustrates a data structure for a list of roads that intersect at a particular intersection, linked to the data structure of FIG. 8b;

FIG. 8d illustrates a data structure for a list of destinations that are reachable from a particular intersection, linked to the data structure of FIG. 8b;

FIG. 9 illustrates a data structure of possible next destinations associated with each destination;

FIG. 10 illustrates a data structure for a particular route associated with a particular driving pattern, linked to the data structure of FIG. 9;

FIG. 11 illustrates a flow chart of anenergy management control process by the energy management system;

FIG. 12 illustrates a flow chart of a route responsive control process that is invoked by the process of FIG. 11;

FIG. 13 illustrates a flow chart of a route processing process that is invoked by the process of FIG. 12; and

FIG. 14 illustrates a flow chart of a predicted route processing process that is invoked by the process of FIG. 13.

### DETAILED DESCRIPTION

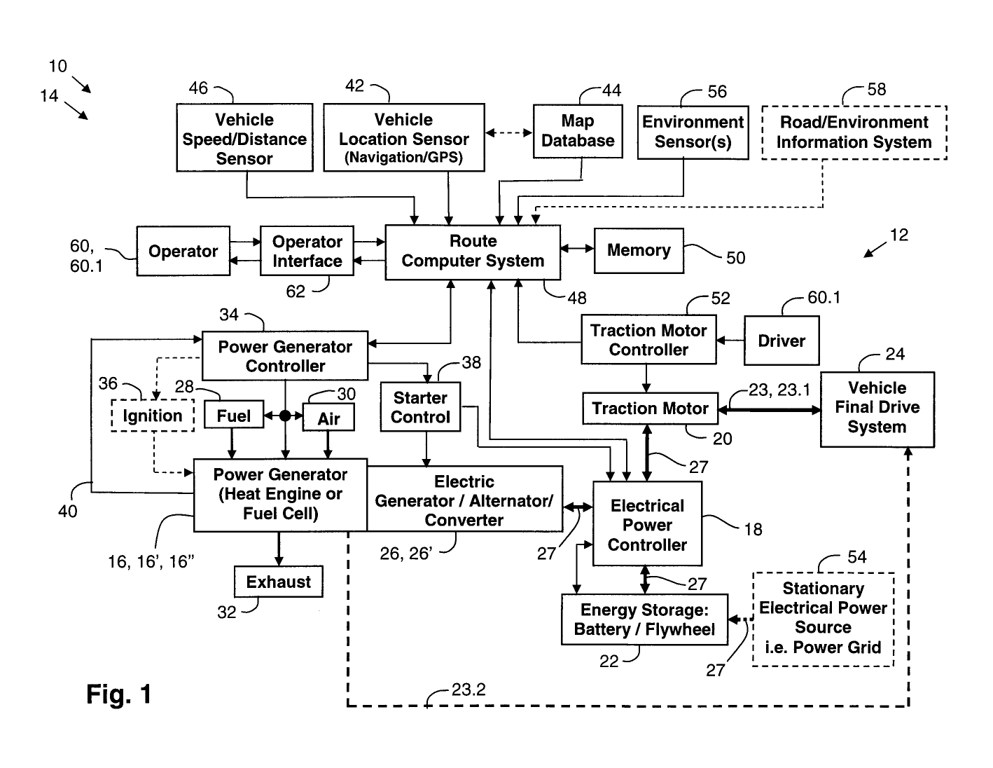

Referring to FIG. 1, an energy management system 10 is adapted to control a hybrid vehicle system 12 so as to provide for improving the efficiency of operation thereof responsive to an automatic recognition of an associated driving pattern of the vehicle 14.

The hybrid vehicle system 12 utilizes a power generator 16 to generate electrical power which is coupled through an electrical power controller 18 to either a traction motor 20 or an energy storage device 22. The electrical power controller 18 also provides for supplying electrical power to the traction motor 20 from the energy storage device 22 as necessary. The vehicle 14 is propel led by shaft power 23 from the traction motor 20 through a final drive system 24 of the vehicle 14, e.g. a differential and associated drive wheels. Alternatively, the traction motor 20 could be implemented as a plurality of in-wheel or hub traction motors 20 so that each of the two or four drive wheels is individually powered. As yet another alternative, one traction motor 20 could be used to power one pair of drive wheels through a differential, and a pair of in-wheel or hub traction motors 20 could be used to power another associated pair of drive wheels. For example, in one embodiment, the power generator 16 comprises a prime mover 16′ comprising a heat engine which generates mechanical power that is coupled to an electric generator or alternator 26 to generate the electric power 27. The prime mover 16′ could operate in accordance with any of a variety of thermodynamic cycles, for example an Otto cycle, a Diesel cycle, a Sterling cycle, a Brayton cycle, or a Rankine cycle. In another embodiment, the power generator 16 comprises a fuel cell 16″ that generates electric power 27 directly, the output of which may be transformed by a power converter 26′ into a form that is suitable for use by the traction motor 20 or energy storage device 22. Generally, the power generator 16 generates power from sources of fuel 28 and air 30 that are combusted or reacted so as to generate energy and an associated stream of exhaust 32. The power generator 16 is controlled by a power generator controller 34, which controls the flow of fuel 28 and air 30 thereinto, and which may also control an associated ignition system 36 thereof. Furthermore, in combination with a power generator 16 comprising a prime mover 16′, the power generator controller 34 is operatively coupled to a starter control system 38 which in turn provides for controlling the electrical power controller 18 to direct power from the energy storage device 22 to the electric generator or alternator 26 which then runs as a motor to provide for starting the power generator 16, in combination with appropriate control of fuel 28, air 30 and the ignition system 36. Furthermore, the power generator controller 34 provides for controlling the fuel 28, air 30 and ignition system 30 responsive to measurements 40 of the operating condition (e.g. RPM, temperature, pressure) the power generator 16 so as to control the power output, operating efficiency, or emissions thereof.

The vehicle 14 also incorporates a vehicle location sensor 42 that cooperates with an associated map database 44, and which may cooperate with a vehicle speed or distance sensor, so as to provide for a measure of the location of the vehicle 14 with respect to a road system upon which the vehicle 14 may travel. For example, the vehicle location sensor 42 may comprise a GPS receiver or other navigation system that determines a location of the vehicle 14 from signals external thereto, or another type of on-board navigation system, e.g. using a differential odometer in combination with a heading from an electronic compass, e.g. a flux-gate compass; or an inertial navigation system. Furthermore, the vehicle location sensor 42 may provide for a measure of vehicle location relative to any particular origin, for example, one's home, work, or a geographic point of reference, e.g. the North or South Pole, the equator and a meridian, e.g. the Greenwich Meridian. For example, a GPS receiver would typically provide location coordinates in accordance with World Geodetic Survey (WGS). The vehicle location sensor 42 may also utilize road map data with an associated map matching algorithm to improve the estimate of vehicle location, wherein a location measurement from the vehicle location sensor 42 is combined with the location of proximate roads, subject to a constraint that the vehicle 14 is located on a road, so as to provide for an improved estimate of vehicle location.

The map database 44 can be generated from existing industry and government sources based upon topographic maps, and would, for example, provide for locations of roads in coordinates of latitude, longitude and elevation, so as to provide for determining the energy requirements of a particular route, particularly previously untraveled routes for which the destination is known. Electronic maps are widely known and used by existing vehicle navigation systems.

The energy management system 10 further comprises a route computer system 48 which receives data from the vehicle location sensor 42 and the map database 44, and which incorporates and/or is operatively coupled to a memory 50 that records vehicle driving patterns. Responsive to the location of the vehicle 14, and the current driving pattern thereof associated with the latest trip, the route computer system 48 attempts to predict the ultimate destination of the vehicle 14 by comparing the present driving pattern with previous driving patterns stored in memory 50, and if a destination can be predicted, provides for controlling the hybrid vehicle system 12 in accordance with the energy and other requirements associated with the remainder of the trip. More particularly, the route computer system 48 provides for controlling the generation of power with the power generator 16 and the transfer of power to or from the energy storage device 22 so as to accomplish a particular objective or set of objectives, such a minimizing fuel consumption subject to reaching the destination or destinations subject to operator control of speed and braking of the vehicle 14.

The power generator 16, energy storage device 22 and traction motor 20 are controlled by the power generator controller 34, the electrical power controller 18 and a traction motor controller 52 respectively, responsive to corresponding signals from the route computer system 48 and the driver 60.1. More particularly, responsive to a signal from an accelerator pedal operated by the driver 60.1, the traction motor controller 52 controls the amount of power that is output from the traction motor 20 to the vehicle final drive system 24, and the power generator 16, electrical power controller 18 and energy storage device 22 are controlled by the route computer system 48 responsive to power demands from the traction motor 20 and responsive associated route dependent energy management by the route computer system 48. The power generator controller 34, electrical power controller 18 and traction motor controller 52 can also be adapted to provide information to the route computer system 48. For example, the electrical power controller 18 would provide information about the amount of energy stored in the energy storage device 22 which would be used by the route computer system 48 in determining a particular overall control strategy.

Electrical power generated by the electric generator or alternator 26 and not required by the traction motor 20 to drive the vehicle 14, or electrical power generated by the traction motor 20 from regenerative braking, can be stored in the energy storage device 22. For example, when electric power 27 is required to be generated by the electric generator or alternator 26, it is beneficial to operate the associated power generator 16 at maximum efficiency, which generally corresponds to a relatively high power operating point, so that there may be more power generated by the electric generator or alternator 26 than might be required by the final drive system 24 to drive the vehicle 14. For example, an internal combustion engine prime mover 16′ would generally operate at maximum brake specific fuel consumption at wide open throttle for which the associated pumping losses are minimized.

The energy storage device 22 may, for example, comprise a battery 22.1, an ultra-capacitor, or a flywheel (e.g. a flywheel in cooperation with an associated motor/generator). For a battery 22.1 energy storage device 22, the energy management system 10 provides for enabling a higher state of charge than might otherwise be provided in a conventional hybrid vehicle system, so as to better accommodate vehicle usage patterns. The characteristics of the battery 22.1, e.g. charging rate, capacity, number of allowable discharge cycles, cost, etc. would depend upon the particular vehicle design, and could considered by the route computer system 48 in determining the overall system control strategy. Generally, a battery 22.1 having a larger storage capacity enables longer periods of operation using stored energy without requiring activation of the power generator 16, which provide for improved system performance. The energy storage device 22 can be charged from a stationary electrical power source 54, e.g. when the vehicle 14 is parked, by plugging into a stationary power supply coupled to the power grid, as an alternative to charging with the power generator 16 during operation of the vehicle 14. This provides for reductions and fuel consumption and emissions generated by the power generator 16, and may reduce associated overall operating costs if the cost of electric power 27 from the stationary electrical power source 54 is less than the cost to generate an equivalent amount of useable electric power 27 using the power generator 16.

The energy management system 10 may further comprise one or more environment sensors 56, for example, a pressure sensor or temperature sensor, so as to provide for environmental information that may be influence the overall control strategy. For example, the ambient temperature can influence the storage characteristics of a battery 22.1 energy storage device 22, or the altitude—sensed from ambient pressure—can influence the operating characteristics of an internal combustion engine or turbine prime mover 16′. Furthermore, environment sensors 56 can be provided to sense dynamic pressure at the front of the vehicle 14 so as to provide for determining a measure of wind speed, which can then be used by the route computer system 48 as a factor in determining the energy required to reach a particular designation.

Furthermore, the energy management system 10 may utilize information from an external road or environment information system 58, such as an external traffic control information system that might provide information about traffic delays or road closures that could be used by the route computer system 48 to select an alternate route to be used in determining the predicted driving pattern for calculating the overall control strategy. Furthermore, the road or environment information system 58 can provide weather information such as wind or precipitation conditions that can be used by the route computer system 48 as a factor in determining the energy required to reach a particular designation.

The operator 60, e.g. driver 60.1, interfaces through an operator interface 62 with the route computer system 48 so as to provide inputs, such as “throttle” and “braking” commands, e.g. with conventional throttle and brake pedals of the vehicle 14, or inputs through one or more switches, touch pads, a keyboard or touch screen. The operator interface 62 is also adapted to generate either aural or visual information, e.g. via the instrument panel. For example, upon recognizing a particular driving pattern, the route computer system 48 could indicate the predicted destination to the operator 60, who could then provide a confirmation or not via a spoken command or by pressing a switch. As another example, the operator 60 could provide a spoken command indicating an intended destination, which would then be used by the route computer system 48 as the most likely destination to be used for calculating the overall control strategy. Typical drive times, distances, energy use, etc. can be provided as information to the operator 60, and the operator 60 can communicate with the route computer system 48 to indicate or confirm intentions so as to improve the overall energy efficiency of the vehicle 14.

While the energy management system 10 can automatically operate without explicit input from the operator 60, the operator interface 62 can be adapted to provide for inputs from the operator 60 that would otherwise need to be automatically learned by the route computer system 48, or to provide for other inputs to enable the operator 60 to better optimize fuel efficiency or overall economy. For example, destinations could be preprogrammed by the operator 60, or set or recorded by the operator upon arriving at the particular destination. Otherwise, the route computer system 48 would automatically record a particular destination location after a given number of occurrences of reaching that particular destination, wherein the given number could be set by the operator 60. Furthermore, the operator 60 could initiate the recording of driving pattern data over a particular trip and stop recording when the associated destination is reached, so as to establish baseline data for determining energy usage. This may be particularly beneficial for routine trips, such as travel between home and work, where a particular route is used repetitively. However, typically the energy management system 10 would operate automatically without the operator 60 having to communicate an intended destination or driving route to the route computer system 48, buy predicting the likely destination of the vehicle 14 based upon probability and correlation with past driving patterns and considering other information such as the time of day, day of week, date, number of occupants, etc.

Furthermore, in combination with the use of a stationary electrical power source 54 to charge the energy storage device 22, price of the power from the stationary electrical power source 54 could either be input to the route computer system 48 by the operator 60 using the operator interface 62, e.g. a keypad, or could be automatically communicated to the route computer system 48 as information modulated on the incoming electric power 27. Accordingly, the route computer system 48 could then advise the operator 60 of the threshold price of fuel 28 above which it would be more economical to use electric power 27 from the stationary electrical power source 54 when possible.

The energy management system 10 can be adapted to operate with various hybrid vehicle architectures. For example, the energy management system 10 is well suited to a series hybrid electric vehicle (HEV) architecture described heretofore, wherein all of the tractive effort to propel the vehicle 14 is from shaft power 23.1 produced by the traction motor 20, which is powered by either the power generator 16, the energy storage device 22, or both the power generator 16 and the energy storage device 22 simultaneously. Alternatively, the energy management system 10 can be adapted to operate with a parallel HEV architecture, wherein the tractive effort to propel the vehicle 14 is provided by a combination of shaft power 23.1 produced by the traction motor 20, and shaft power 23.2 produced by the power generator 16 and coupled to the final drive system 24, for example, with a traction motor 20, or a pair of traction motors 20, driving the front wheels of the vehicle, 14, and an internal combustion engine, e.g. a Diesel engine, power generator 16 driving the rear wheels through a differential. The energy management system 10 can also be adapted to operate with other HEV architectures, such as charge sustaining or charge depleting architectures, or HEV systems incorporating power split drive trains.

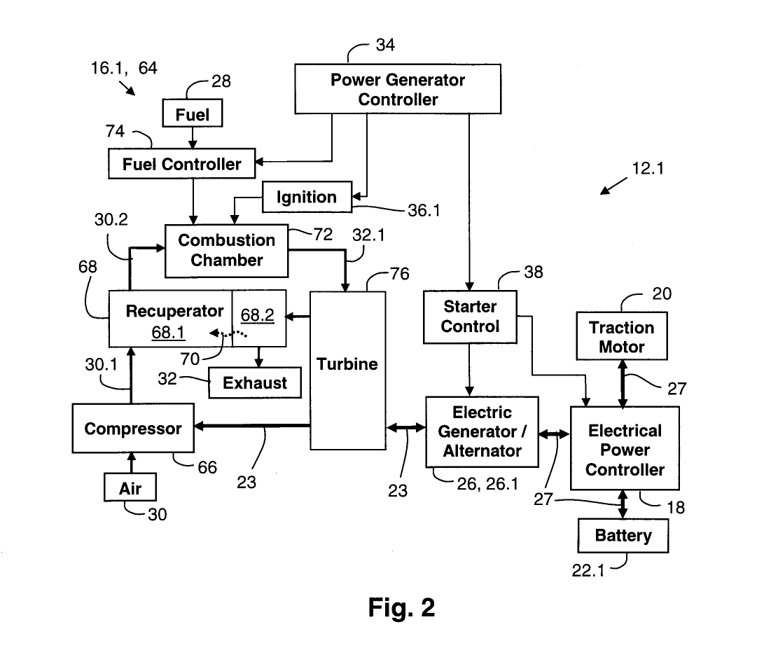

Referring to FIG. 2, a hybrid vehicle system 12.1 is illustrated incorporating a recuperated turbine engine 64 as the power generator 16.1. Air 30 compressed by a compressor 66 flows through a first flow path 68.1 of a recuperator 68, which heats the compressed air flow using heat 70 extracted from exhaust 32 flowing though through a second flow path 68.2 of the recuperator 68. The first 68.1 and second 68.2 flow paths of the recuperator 68 are adapted to exchange heat therebetween but are otherwise isolated from one another. The heated compressed air 30.2 flows into a combustion chamber 72 where it is mixed with fuel 28 injected therein responsive to a fuel controller 74, and combusted to generate a relatively high temperature exhaust 32.1, which is used to drive a turbine 76, which generates the shaft power 23 used to drive the compressor 66. The turbine 76 also drives the electric generator or alternator 26 operatively coupled thereto, either directly as illustrated, or through a gear reduction assembly. For example, in one embodiment, a four pole electric alternator 26.1 is driven directly by the turbine 76 at a speeds in excess of 120,000 RPM. The recuperator 68 transfers heat 70 from the relatively high temperature exhaust 32.1 out of the turbine 76, to the compressed air 30.1 out of the compressor 66. An ignition system 36.1 operatively associated with the combustion chamber 72 is used to initiate combustion therein. The fuel controller 74 and ignition system 36.1 are operatively coupled to the power generator controller 34 and are controlled responsive to signals therefrom. Generally, the power generator controller 34 would also monitor and use signals from the recuperated turbine engine 64, such as output shaft speed, inlet air temperature, compressed air temperature and/or exhaust temperature in determining the appropriate associated control signal for the fuel controller, either directly, or responsive to a signal from the associated route computer system 48. For example, the performance of a turbine engine generally improves as the temperature of the ambient air is reduced, so that a measure of ambient air temperature can be used to optimize the use and operation of the recuperated turbine engine 64 in the hybrid vehicle system 12.1.

The recuperator 68 can store a substantial amount of heat energy during the operation of the recuperated turbine engine 64, at least a portion of which can be recovered by shutting off or reducing the flow of fuel 28 prior to reaching a destination, whereby the heat energy stored in the recuperator 68 heats the compressed air 30.1 sufficiently to provide for continued extraction of power from the turbine 76. This power—which requires no fuel usage to generate, and which would otherwise be lost—can be used to either store energy in the battery 22.1, or to drive the traction motor 20. A recuperated turbine engine 64 can generate energy more efficiently by reducing fuel flow while regulating power output to more efficiently recover latent heat energy from the recuperator 68. For example, an operating recuperated turbine engine 64 might provide 32 percent thermal efficiency at constant output, whereas latent heat recovery can provide for 34 to 35 percent thermal efficiency under conditions of reduced fuel flow and reduced power output in advance of an engine idle condition. Accordingly, if the route computer system 48 is able to predict a destination of the vehicle and determine its location relative thereto, the flow of fuel 28 to the recuperated turbine engine 64 can be shut off, reduced, or tapered down sufficiently far in advance of reaching the destination so as to provide for recovering the heat energy from the recuperator 68 as electrical energy that is either stored in the battery 22.1 or used to drive the vehicle 14. Furthermore, the residual heat energy stored in the recuperator 68 provides for temporarily shutting off fuel 28, e.g. for periods of 10-60 seconds when the power generator 16 is not needed, and then restarting the recuperated turbine engine 64 by simply resuming fuel 28 flow thereto, without requiring restart by the starter control system 38, whereby the heated compressed air 30.2 out of the recuperator 68 provides sufficient energy to continue to run the recuperated turbine engine 64 for a period of time even with the fuel 28 shutoff.

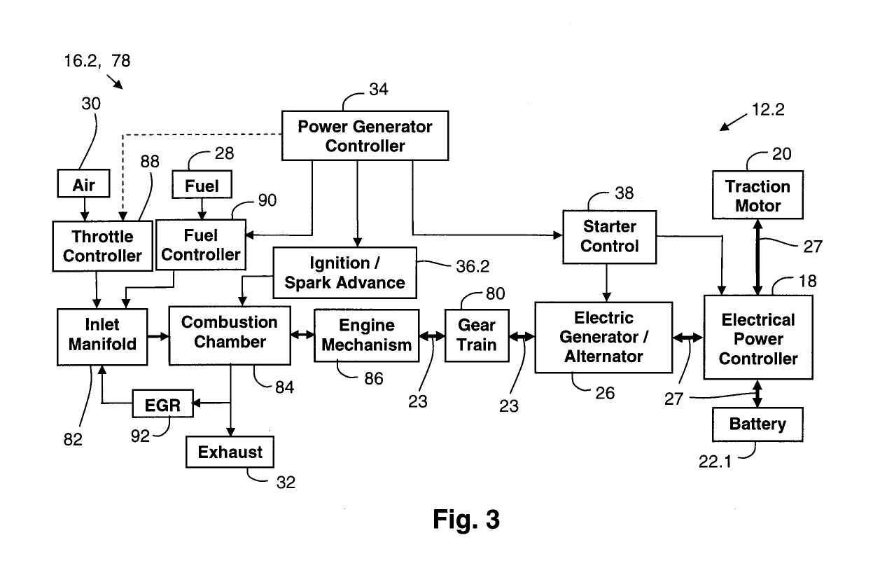

Referring to FIG. 3, a hybrid vehicle system 12.2 is illustrated incorporating an internal combustion engine 78 as the power generator 16.2, wherein the electric generator or alternator 26 would typically be driven through an associated gear train 80 adapted so that the electric generator or alternator 26 rotates faster than the internal combustion engine 78, so as to provide for a relatively smaller electric generator or alternator 26 than would otherwise be required. Air 30 is drawn through an inlet manifold 82 into a combustion chamber 84 responsive to the motion of an associated engine mechanism 86 (e.g. pistons, connecting rods, crankshaft, camshaft and valve train assembly. The flow of air 30 is controlled by a throttle assembly, the positions of which may be controlled by a throttle controller 88 responsive to a signal from the associated power generator controller 34. Alternatively, the throttle assembly could be eliminated in systems for which the internal combustion engine 80, when operated, is always run under wide open throttle (WOT) conditions so as to minimize associated engine pumping losses. In a naturally aspirated engine, the air 30 is pumped strictly responsive to the action of the engine mechanism 86. Alternatively, the internal combustion engine 80 could incorporate either a supercharger or a turbocharger to provide for supplemental pumping effort. The air 30 is combined with fuel 28 injected into the inlet manifold 82 under control of a fuel controller 90 responsive to a signal from the power generator controller 34 The air 30 and fuel 28 are combusted in the combustion chamber 84 responsive to repetitive ignition by either a spark ignition system 36.2 for operation in accordance with an Otto cycle, or by compression for operation in accordance with a Diesel cycle. A portion of the resulting exhaust 32 may be fed back into the inlet manifold 82 through an exhaust gas recirculation (EGR) valve 92. Generally, the power generator controller 34 would also monitor and use signals from the internal combustion engine 80, such as crankshaft speed (engine RPM), inlet air temperature and/or inlet air flow in determining the appropriate associated control signal for the fuel controller, either directly, or responsive to a signal from the associated route computer system 48. Generally, the fuel, spark advance and exhaust gas recirculation may be used as control signals to control the operation of the internal combustion engine 80, for example, with the objective of minimizing fuel consumption subject to constraints on the amount of associated emissions that are generated in the exhaust 32.

General ly, the hybrid vehicle system 12 provides for operation with reduced fuel consumption and improved emissions by providing for operating the power generator 16 in a mode that can be selected to optimize fuel consumption subject to constraints on emissions, independent of the particular driving cycle under which the vehicle 14 is operated. A difference between the power actually generated by the power generator 16 and the amount of power required to actually drive the vehicle 14 can then be accommodated by the associated energy storage device 22. For example, if the power generator 16 were an internal combustion engine 80 that is operated most efficiently at wide open throttle, then, under driving conditions for which the power output level of the power generator 16 was greater than that necessary to drive the vehicle 14, either the excess power from the power generator 16 can be stored in the energy storage device 22, or, if there was sufficient stored energy in the energy storage device 22, the vehicle 14 could be operated strictly on energy from the energy storage device 22 without operating the power generator 16. Under driving conditions requiring more power than can be generated by the power generator 16, the vehicle 14 can be operated from energy stored in the energy storage device 22, and if necessary, power generated by the power generator 16. Accordingly, the control of the hybrid vehicle system 12 involves determining whether or not, and if so, under what conditions, to run the power generator 16, whether to store energy in the energy storage device 22 or to utilize energy therefrom, and, particularly for a battery 22.1, determining the target state of charge of the energy storage device 22. The nature of the particular control strategy depends upon a variety of factors. For example, for relatively short trips that can be accomplished strictly with stored energy from the energy storage device 22, it may be beneficial to operate entirely on stored energy, without operating the power generator 16. The optimal state of charge of the battery 22.1 at one destination may depend upon what the next destination is likely to be. For example, if the cost of power from a stationary electrical power source 54 is less than the cost to generate an equivalent amount of power using the power generator 16, and if a round-trip between first and second destinations can be accomplished using stored energy from the energy storage device 22, then the vehicle 14 might best be operated without activating the power generator 16, notwithstanding that the state of charge of the battery 22.1 upon reaching the second destination might be lower than what might otherwise be desirable if the vehicle 14 were operated under some other condition. Furthermore, for a hybrid vehicle system 12.1 incorporating a recuperated turbine engine 64, then under driving conditions for which the recuperated turbine engine 64 is operated, it is beneficial to be able to control the recuperated turbine engine 64 prior to reaching a destination so that the heat energy stored in the recuperator 68 can be extracted. Accordingly, the operation of a hybrid vehicle system 12 can be improved if it is possible to predict the particular driving pattern of the vehicle.

This is possible using the energy management system 10 generally illustrated in FIG. 1, which provides for 1) monitoring the location of the vehicle 14 using a vehicle location sensor 42 and associated map database 44, 2) determining if a particular driving pattern of the vehicle 14 matches a stored driving pattern so that the destination can be predicted, and 3) if the destination can be predicted, predicting the energy or power requirements of associated with the particular driving pattern, and determining the associated control strategy for the power generator 16, electrical power controller 18, traction motor 20 and energy storage device 22 responsive to the particular driving pattern.

Referring to FIG. 4, there is shown a portion of a map 100 which is used to illustrate various aspects and terminology associated with the operations of monitoring the location of the vehicle 14, storing associated driving patterns of the vehicle 14, and determining whether a particular driving pattern of the vehicle 14 corresponds to a stored driving pattern. Overlaid on the map 100 is a grid of longitude 102: i and latitude 104: j coordinates which define an array of location cells 106, (ij). The map 100 contains a plurality of roads 108: 108.1, 108.2, 108.3 which intersect with one another at a plurality of intersections 110: 110.1, 110.2, 110.3 at associated nodes 106 of the associated intersecting roads (108.1, 108.3), (108.1, 108.2), (108.2, 108.3) The roads 108: 108.1, 108.2, 108.3 are stored in memory as a discretized representation comprising a plurality of nodes 112, wherein the location of the road 108 at any point between adjacent nodes 112 can be found by interpolating therebetween, for example, by linear, quadratic or cubic interpolation, or some other interpolation method. A plurality of destinations 114: A, B, C, D are illustrated, which represent locations that satisfy a predetermined destination criteria, for example locations that the vehicle 14 had either stopped at a sufficient number of times during its past operation, or locations that were explicitly selected or entered into the route computer system 48 by the operator 60. In FIG. 4, two of the destinations 114: B, D are illustrated as being coincident with corresponding nodes 112 of the associated proximate roads 108: 108.3, 108.1, and two of the destinations 114: A, C are illustrated as being located between nodes 112 along the associated proximate roads 108: 108.1, 108.2. Destinations that are sufficiently proximate to one another are grouped together into what is referred to as a destination circle 116, wherein the size of a destination circle 116 is adapted so that energy required for the vehicle transit the destination circle 116 is less than a threshold, and the location associated with a given destination circle 116 would be, for example, that of a location closest to the center of the destination circle 116 along a proximate road 108. Accordingly, the destination circle 116 provides for reducing the number of locations and the associated computational burden required to predict a particular driving pattern of the vehicle 14 in order for the energy management system 10 to benefit from control of the hybrid vehicle system 12 responsive to the prediction of the driving pattern and associated energy requirements, without substantially affecting the associated energy calculations used to automatically implement a predestination shutdown of the power generator 116. In FIG. 4, there are three destination circles 116: 116.1, 116.2, 116.3 illustrated, wherein the first destination circle 116.1 includes destinations A and D, and the second 116.2 and third 116.3 destination circles include destinations B and C respectively. For example, destination circles 116 would be relatively closely grouped destinations 114 that are within a given distance of one another, e.g. about a half mile, or a destination circle 116 that is about 1,500 feet from the associated mean destination. For example, a shopping center with different stores in relatively close proximity would be represented as a destination circle 116, the location of which would be used to represent that of each of the particular destinations 114, e.g. stores, contained therein. Different destinations 114 or sets of destinations 114 could have different associated location error tolerances represented by the radius of the associated destination circle 116. For example, principal destinations 114 such as “home” could have a location error tolerance of about 200 feet. The route computer system 48 would automatically cluster proximate destinations 114 into a corresponding, single destination circle 116.

The map database 44 may further comprise topographic information such as the elevation 118 associated with each of the nodes 112 on the roads 108, from which the associated potential energy difference can be calculated for different locations along roads 108 in the map 100.

In FIG. 4, the vehicle 14 is illustrated as having departed from a first destination 114.1: A, and currently traveling along a first road 108.1 in a Northeast direction approaching a second intersection 110.2, on a route that continues on the first road 108.1 until turning right at a first intersection 110.1 onto a third road 108.3 until reaching a second destination 114.2: B, wherein the route being traveled is shown with a wider line width than are the other segments of the roads 108. The destinations 114 and associated destination circles 116 illustrated in FIG. 4, and the associated information about the associated driving patterns, are stored in the memory 50 associated with the route computer system 48. For example, at the present location of the vehicle 14 illustrated in FIG. 4, the route computer system 48 would be able to look ahead along the first road 108.1 to find intersection 110.2, for which destinations B and C would be indicated as possible destinations that are reachable therefrom, so that the route computer system 48 would be able to predict that the maximum amount of energy required to reach a destination would be that associated with either destination B or destination C, whichever is larger. Furthermore, if a the particular date and/or time, destination B were more likely than destination C, then the route computer system 48 could determine that destination B was the more likely of the two destinations B, C. Upon passing through the second intersection 110.2, the route computer system 48 would be able to look ahead along the first road 108.1 to find the first intersection 110.1, for which the only destination reachable would be destination B, so that destination B would be indicated as the most likely destination 114. Given a most likely destination 114, the route computer system 48 can then determine the distance and energy required to reach the destination 114, either from past stored measurements or associated mean values, or by calculation from the associated mapping data, including changes in potential energy due to topographic elevation 118 changes between the current location and the likely destination B.

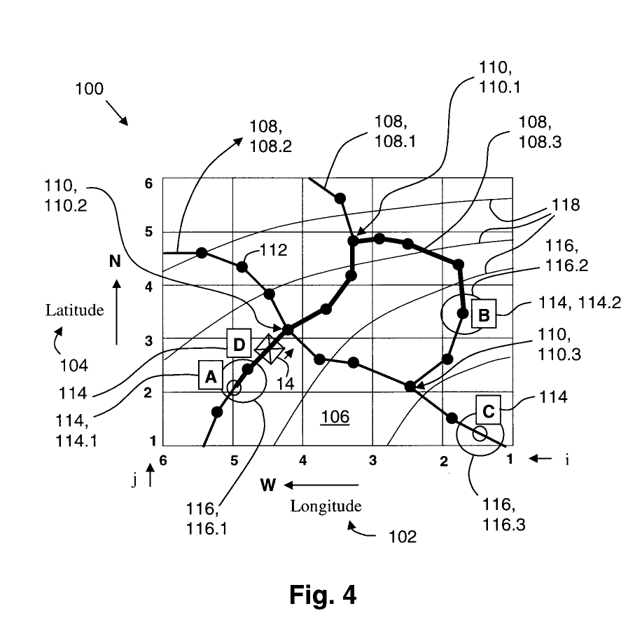

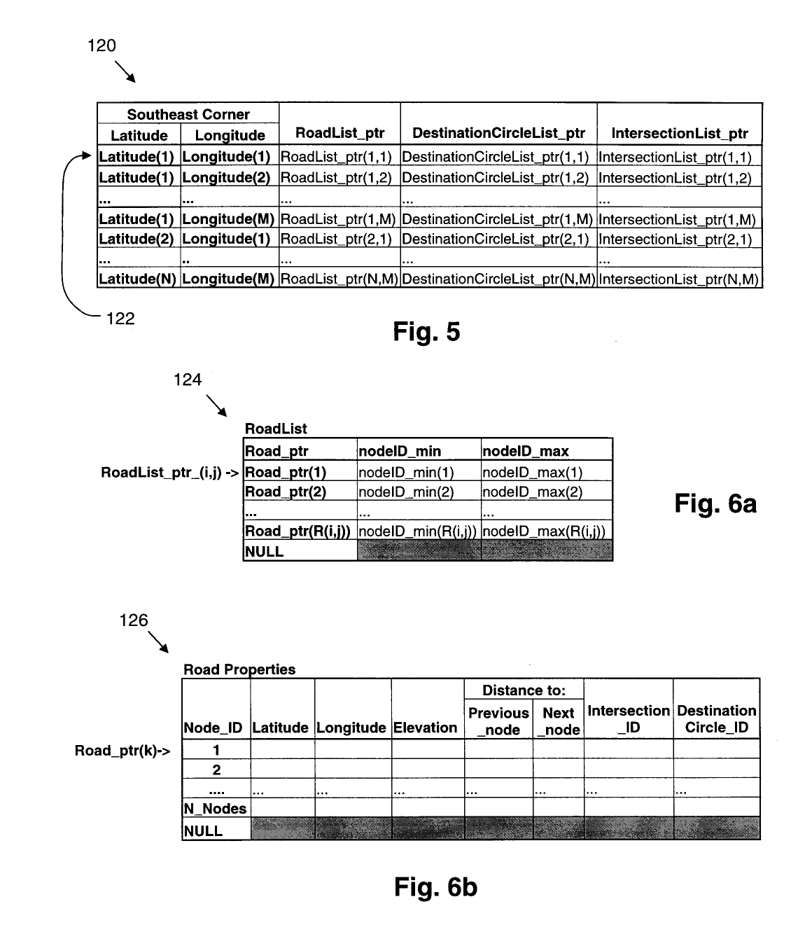

Referring to FIGS. 5 through 10, there is illustrated an example of a group of data structures which would be stored in the memory 50 and map database 44 of the route computer system 48 that can provide for storing and predicting vehicle driving patterns and associated energy requirements of the vehicle 14.

Given a measure of location, i.e. latitude 104 and longitude 102, of the vehicle 14 at a particular point in time, the data structure 120 illustrated in FIG. 5 provides for determining the roads 108, destination circles 116 and intersections 110 within the location cell 106 of the map 100 within which the vehicle 14 is located. The data structure 120 comprises a plurality of records 122, wherein each record 122 contains a value for each of a plurality of fields identified by the headings in the top line of the data structure 120, i.e. Latitude, Longitude, etc. More particularly, each record 122 of the data structure 120 corresponds to the particular location cell 106 of the map 100 having a southeast corner corresponding to the values of latitude and longitude from the associated fields of the data structure 120, wherein the location cells 106 cover a given range of longitudes and latitudes. Accordingly, the records 122 correspond to corresponding longitude and latitude coordinates (i,j) of the southeast corners of the location cells 106, e.g. as illustrated in FIG. 4. The route computer system 48 uses measures of latitude and longitude from the vehicle location sensor 42 to determine the particular record 122 of the data structure 120 associated with the location of the vehicle 14. Then, corresponding values for the fields RoadList_ptr, DestinationCircleList_ptr and IntersectionList_ptr for that particular record 122—indexed as (i,j)—are then used to determine the associated road(s) 108, destination circle(s) 116, and intersection(s) 110 that may be located within the location cell 106 of the map 100 in which the vehicle 14 is located.

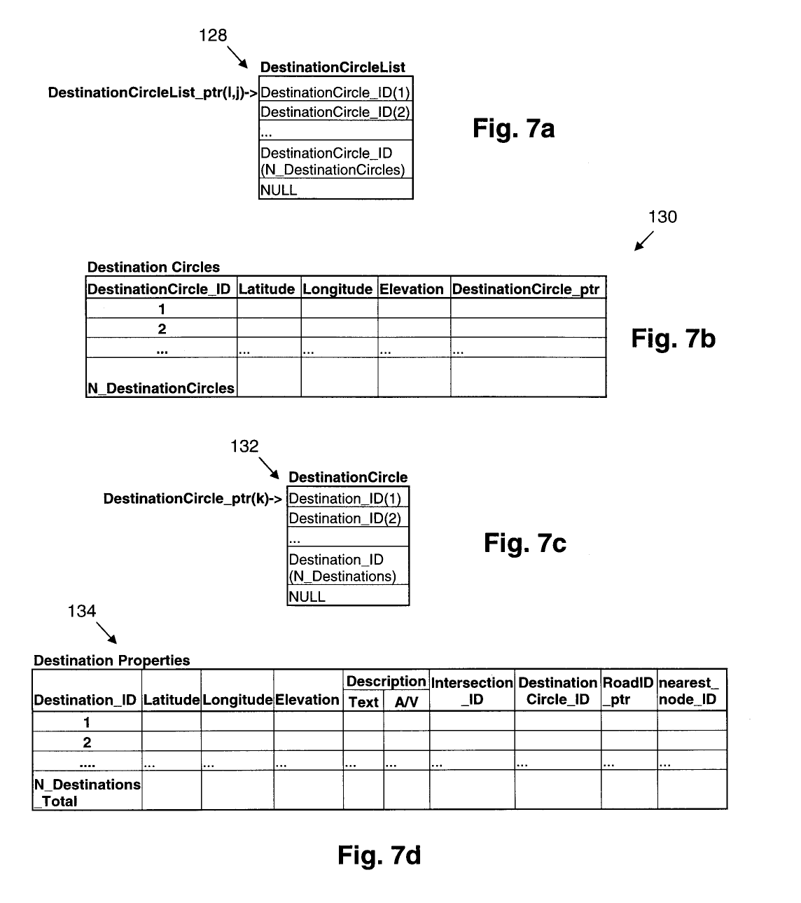

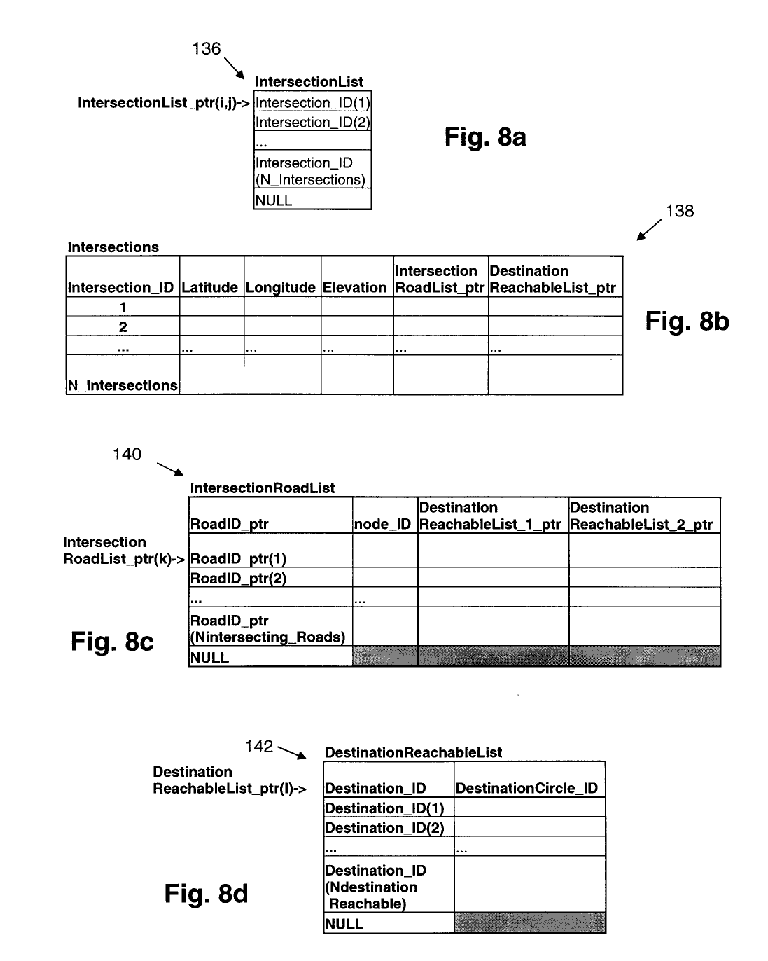

The value RoadList_ptr(i,j) of the RoadList_ptr field of the record 122 of the data structure 120 associated with the location of the vehicle 14 is a pointer to a linked list data structure 124 illustrated in FIG. 6a, wherein each of R(ij) records of the linked list data structure 124 has values for the fields Road_ptr, nodeID_min, and nodeID_max. Road_ptr is a pointer to a linked list data structure 126 illustrated in FIG. 6b of properties for a particular road in the map database 44, and nodeID_min and nodeID_max are the minimum and maximum values of the index Node_ID of the portion of the road 108 identified by the pointer Road_ptr(k), wherein k can range between nodeID_min and nodeID_max within the location cell 106 of the map 100 in which the vehicle 14 is located. Each record of the linked list data structure 126 of road properties contains values of latitude, longitude, elevation, and distance to the previous and next node 112, for each node 112 of the particular road pointed to by the pointer Road_ptr(k). If a particular node 112 is also associated with an intersection 110 or a destination circle 116, then values of the associated index of the intersection 110 or destination circle 116 are also stored in the associated record of the linked list data structure 126, wherein the respective indices are associated with the respective data structures illustrated in FIGS. 8b and 7b respectively.

The value DestinationCircleList_ptr(i,j) of the DestinationCircleList_ptr field of the record 122 of the data structure 120 associated with the location of the vehicle 14 is a pointer to a linked list data structure 128 illustrated in FIG. 7a, wherein each record of the linked list data structure 128 has a value for the field DestinationCircleList_ID, which is an index to a particular record of a data structure 130 illustrated in FIG. 7b containing information about each destination circle 116, including the latitude, longitude and elevation of the center of the destination circle 116; and a pointer DestinationCircle_ptr to a linked list data structure 132 illustrated in FIG. 7c containing a list of indexes Destination_ID, each of which identifies a destination 114 that is part of a particular destination circle 116. Each record of the linked list data structure 132 is an index to a data structure 134 illustrated in FIG. 7d of properties for each of the destinations, each of which is designated by an associated index Destination_ID, including the latitude, longitude and elevation of the destination; a text or audio/visual message used to identify the destination 114 to the operator 60; the index Intersection_ID associated with the data structure illustrated in FIG. 8b identifying a proximate intersection 110 if there is an intersection 110 proximate to the destination 114; the index DestinationCircle_ID of the destination circle 116 of which the particular destination 114 is a part with of the data structure 130 of FIG. 7b; and the pointer RoadID_ptr and the index nearest_node_ID of the linked list data structure 126 of FIG. 6b, which identify the nearest node 112 on the road 108 on which the destination 114 is located.

The value IntersectionList_ptr(i,j) of the IntersectionList_ptr field of the record 122 of the data structure 120 associated with the location of the vehicle 14 is a pointer to a linked list data structure 136 illustrated in FIG. 8a, wherein each record of the linked list data structure 136 has a value for the field Intersection_ID, which is an index to a particular record of a data structure 138 illustrated in FIG. 8b containing information about each intersection 110, including the latitude, longitude and elevation of the intersection 110; a pointer InteresectionRoadList_ptr to a linked list data structure 140 illustrated in FIG. 8c; and a pointer DestinationReachableList_ptr to a linked list data structure 142 illustrated in FIG. 8d. The linked list data structure 140 of FIG. 8c contains a list of pointers RoadID_ptr to the records of the linked list data structure 126 of FIG. 6b, each record corresponding to a particular road 108 that intersects at the intersection 110; and a value node_ID of the node 122 of the road 108 at the intersection 110. The linked list data structure 140 also contains pointers DestinationReachableList_1_ptr and DestinationReachableList_1_ptr to linked list data structures 142 illustrated in FIG. 8d, which contain lists of destinations 114 and destination circles 116 that are reachable from the particular intersection 110 along the particular road 108 in directions of decreasing node_ID and increasing node_ID respectively. The linked list data structure 142 of FIG. 8d contains a list of values of indexes Destination_ID and DestinationCircle_ID which designate destinations 114 and associated destination circles 116 that are reachable from the particular intersection 110, and which refer to corresponding data structures 134, 130 illustrated in FIGS. 7d and 7b respectively.

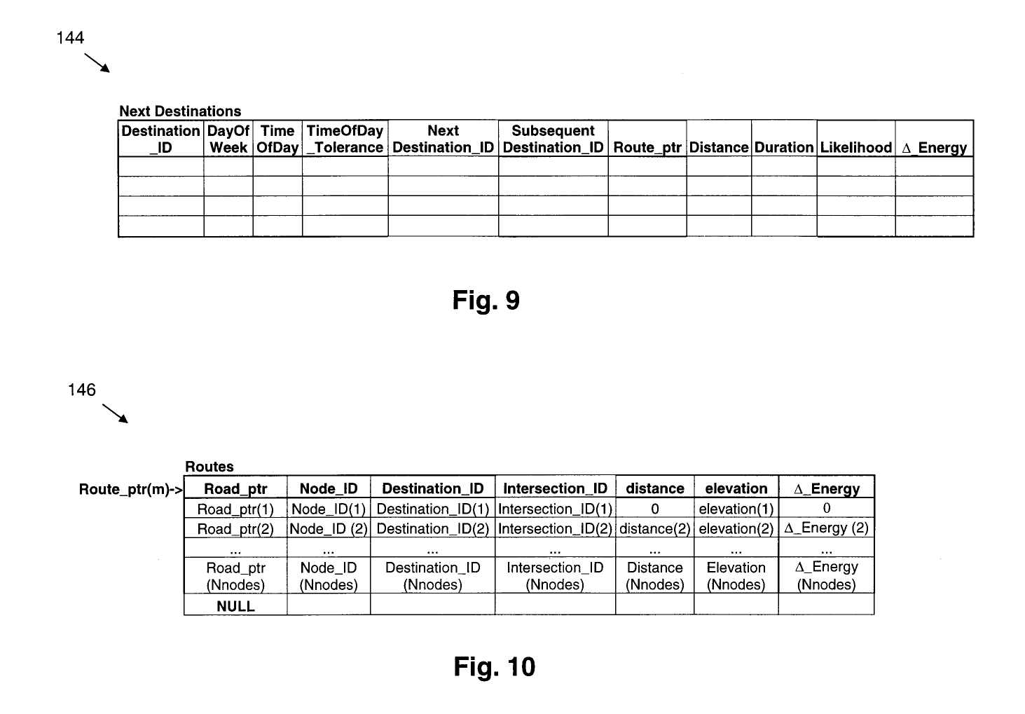

Upon traveling on a particular route in accordance with a particular driving pattern from a first destination 114.1 to a second destination 114.2, the route computer system 48 records the a summary of the driving pattern in a data structure 144 illustrated in FIG. 9, and records the details of the driving pattern in a linked list data structure 146 illustrated in FIG. 10. More particularly, for each driving pattern, the data structure 146 contains an index to the first destination 114.1 with reference to the data structure 134 of FIG. 7d in the field Destination_ID, and the day of week and time of day when the trip was commenced in respective DayOfWeek and TimeOfDay fields. Upon reaching the second destination 114.2, the index of the second destination 114.2 is recorded in the NextDestination_ID field. The Distance, Duration and □_Energy fields contain the distance traveled between the first 114.1 and second 114.2 destinations, the trip duration, and an estimate of the energy consumed therebetween, respectively, or average values thereof. As particular driving patterns are followed over time, the route computer system 48 can determine associated statistics, so as to provide for values of associated Likelihood and TimeOfDay_Tolerance fields of the associated record in the data structure 144. For example, over time a particular driving pattern may be used repetitively, such as driving from home to work in the morning, or driving from work to home in the evening. The starting times of the corresponding repetitive trips would tend to cluster in a group that, for example, might be characterized by a normal distribution having a mean and standard deviation. Accordingly, the TimeOfDay_Tolerance could, for example, be a value expressed in terms of the standard distribution of the group of clustered starting times. For the same day of week and time of day, there may be several different driving patterns that develop over time, in which case, different driving patterns will have different associated likelihoods, which are calculated over time by the route computer system 48 and stored in the Likelihood field of the data structure 144.

The Route_ptr field of the data structure 144 of FIG. 9 contains a pointer to the linked list data structure 146 of FIG. 10 containing the details of the driving pattern of the route traveled. The first record of the linked list data structure 146 contains the index of the first destination 114.1 which is stored as Destination_ID(1) in the field Destination_ID. If the first destination 114.1 is associated with a particular node 112 of a road 108, then the corresponding pointer Road_ptr to that road 108, the index Node_ID of that node 112 and the associated elevation 118 are also recorded in the corresponding record of the linked list data structure 146. Furthermore, if the node 112 is at an intersection 110, then the index Intersection_ID of that intersection 110 is also in the corresponding record of the linked list data structure 146. As the vehicle 14 travels along the road or roads 108, these steps are repeated for each node 112 or destination 114 along the route, and the distance from the first destination 114.1 and the energy consumed either since the first destination 114.1 or since the previous node 112 are recorded in the distance and □_Energy fields respectively. Upon reaching the second destination 114.2, the information in the data structure 144 of next destinations illustrated in FIG. 9 is updated, and using the route information from the linked list data structure 146, the linked list data structures 142 of FIG. 8d are updated for each intersection 110 and road 108 along the route, so as to add the first 114.1 and second 114.2 destinations and associated destination circles 116 to the list of reachable destinations from those intersections 110 along those roads 108. Accordingly, the linked list data structure 142 of FIG. 8d contains indices for the destinations 114 and destination circles 116 that have been actually reached in accordance with the historical driving patterns of the vehicle 14. This information could also be tailored to particular drivers 60.1, so as to provide for accommodating different driving patterns for different drivers 60.1 of the same vehicle 14, thereby improving the accuracy of associated predictions of driving patterns during operation of the vehicle 14. Furthermore, upon reaching the next destination 114 on a subsequent trip, the associated index of this destination 114 is recorded in the Subsequent Destination_ID field of the data structure 144 of FIG. 9, so as to provide for future predictions of the next subsequent trip associated with the original first destination 114.1.

The data structures illustrated in FIGS. 5 through 10 can be used to retrieve a variety of useful information.

For example, given a measure of location, i.e. latitude 104 and longitude 102, of the vehicle 14 at a particular point in time, the corresponding pointer RoadList_ptr from the data structure 120 of FIG. 5 can be used to find, from the linked list data structure 124 of FIG. 6a, pointers Road_ptr and associated ranges of indices nodeID_min and nodeID_max to the linked list data structure 126 of FIG. 6b, whereby for the range of nodes 112 between nodeID_min and nodeID_max, the latitude 104 and longitude 102 from the linked list data structure 126 of FIG. 6b can be compared with the latitude 104 and longitude 102 of the vehicle 14 from the vehicle location sensor 42 to determine the road 108 and node 112 thereof upon which and at which the vehicle 14 is located.

As another example, given a measure of location, i.e. latitude 104 and longitude 102, of the vehicle 14 at a particular point in time, the corresponding pointer DestinationCircle_ptr from the data structure 120 of FIG. 5 can be used to find, from the linked list data structure 128 of FIG. 7a, indices DestinationCircle_ID to the data structure 130 of FIG. 7b, which provides, for each destination circle 116, a pointer DestinationCircle_ptr to the linked list data structure 132 of FIG. 7c containing a list of indices of the associated destinations 114, which can be searched to determine whether of not the vehicle 14 is in general proximity to a particular destination 114. Furthermore, using the data structure 134 of FIG. 7d which provides the latitude 104 and longitude 102 of each destination, or the data structure 130 of FIG. 7b which provides the latitude 104 and longitude 102 of each destination circle 116, the route computer system 48 can determine whether the vehicle 14 is located at a particular destination 114 or within a particular destination circle 116.

As yet another example, given a measure of location, i.e. latitude 104 and longitude 102, of the vehicle 14 at a particular point in time, the corresponding pointer IntersectionList_ptr from the data structure 120 of FIG. 5 can be used to find, from the linked list data structure 136 of FIG. 8a, indices Intersection_ID to the data structure 138 of FIG. 8b, which provides, for each intersection 110, a pointer DestinationReachableList_ptr to the linked list data structure 142 of FIG. 8d containing a list of indices of the associated destinations 114 and destination circles 116 that are reachable from that intersection 110, which can be searched to determine whether of not the vehicle 14 could be traveling to a particular destination 114 or destination circle 116. If the second destination 114.2 predicted by the route computer system 48 is not part of a list of those reachable from the present location of the vehicle 14, then the predicted second destination 114.2 would need to be revised by the route computer system 48. This operation can be further refined to consider only destinations 114 that are reachable in the present direction of travel, by using the linked list data structures 142 pointed to by the pointers DestinationReachableList_1_ptr or DestinationReachableList_2_ptr from the linked list data structure 140 of FIG. 8c addressed by the pointer IntersectionRoadList_ptr from the data structure 138 of FIG. 8b, depending upon the road 108 upon which vehicle 14 is traveling and the direction of travel thereon.

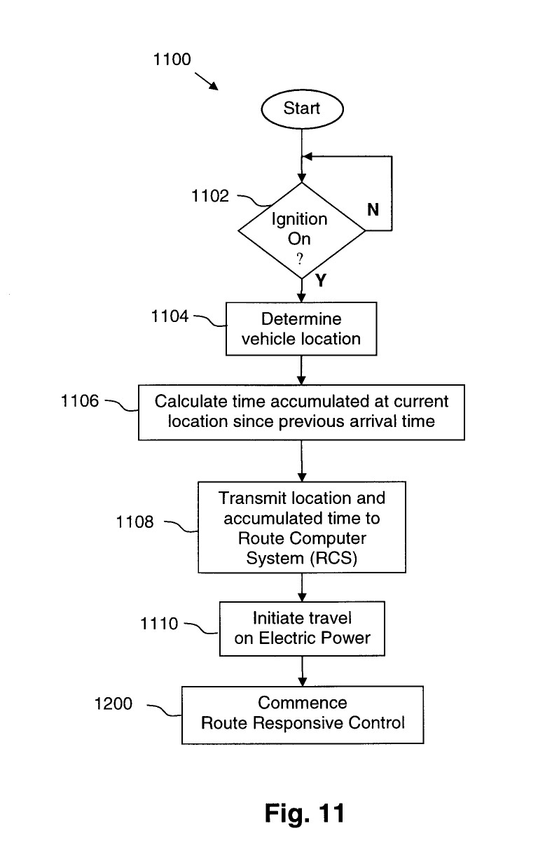

Given the energy management system 10 illustrated in Figs., and the example of associated data structures 120, 124-146 illustrated in FIGS. 5 through 10, the operation of the energy management system 10 will now be described with reference to the flow charts illustrated in FIGS. 11 through 14.

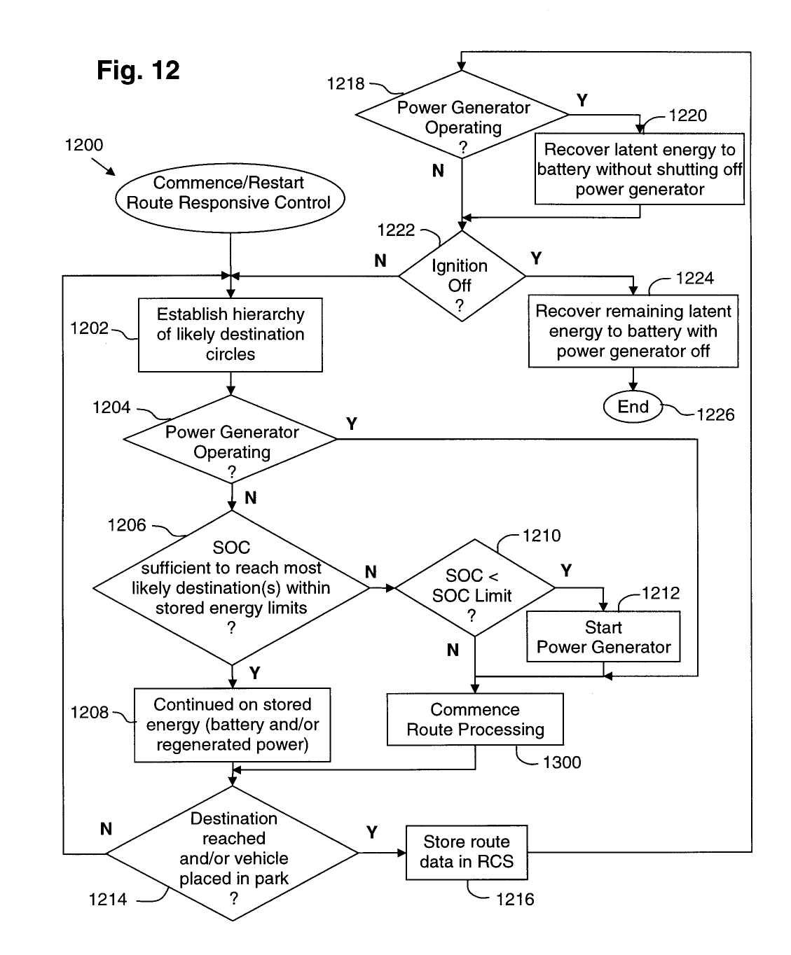

Referring to FIG. 11, the energy management system 10 commences an associated energy management control process (1100) with step (1102) by checking the state of the vehicle ignition key. If the vehicle ignition key is on, the location, i.e. latitude 104 and longitude 102 (and elevation 118 if available), of the vehicle 14 are determined in step (1104) from the vehicle location sensor 42, e.g. GPS system. When the vehicle ignition key is turned on, the vehicle 14 will in most cases will be at a destination 114, in which case the time that has been accumulated since first arriving at that destination is calculated in step (1106). If the processes of steps (1102) through (1106) are not performed by the route computer system 48, then in step (1108), the location of the vehicle 14 and the time accumulated at the current location are transmitted to the route computer system 48. In step (1110), travel of the vehicle 14 is commenced on electric power from the energy storage device 22, e.g. battery 22.1, assuming that there is sufficient stored energy to do so, as would typically be the case for a series hybrid electric vehicle. Then, the route computer system 48 commences a route responsive control process (1200), which is illustrated in FIG. 12.

Referring to FIG. 12, the route responsive control process (1200) commences with step (1202) wherein the route computer system 48 establishes a hierarchy of likely destination circles 116, for example, by ranking the Likelihood values from the data structure 144 of FIG. 9, for the Destination_ID of the destination 114 corresponding to the starting location of the vehicle 14, weighted according to or governed by the day of week and time of day in comparison with the associated DayOfWeek, TimeOfDay and TimeOfDay_Tolerance values from the data structure 144, which is learned by the route computer system 48 from previous trips by the vehicle 14.

For example, for many drivers 60.1, the most likely destination might be the location of their home, followed by the driver's work location which would be relatively highly likely during normal work days and normal departure times. Various destination circles 116 would also likely become predictable, depending upon the day of week and time of day. Although weekend driving patterns are likely to be more random, probable destinations will be learned and identified by the route computer system 48. Generally, the route computersystem 48 continuously determines the next probable destination 114 of the vehicle 14, which generally would be situation dependent.

As a highest probability default from any point of origin, the route computer system 48 would typically provide for a default stored energy range corresponding to a predetermined travel distance. For example, if the default energy range is one mile, then the power generator 16 would not start until that circle distance from the origin was achieved. This would prevent unnecessarily starting the power generator 16 for short distance travel or simply moving the vehicle 14 in a driveway or parking lot. Additionally, this stored energy range would serve to increase the probability of predicting a destination 114 based on the particular route, day of week, date, time, etc after initiating a particular driving pattern. A greater stored energy range available provides for reducing the likelihood of requiring operation of the power generator 16. However, when the power generator 16 is operated, it provides for relatively higher power, relatively more efficient generation of electric power 27 to charge the energy storage device 22 in a relatively short period of time, after which the route computer system 48 can revert to driving on stored energy when the destination 114 becomes relatively highly predicted.

When the location of origination is a destination 114 corresponding to the driver's home, the most likely destinations 114 therefrom can be dependent upon the day of week and time of day. For example, for a typical work schedule of Monday through Friday with possible weekend work activity, the vehicle 14 would typically be driven to a work destination 114 in the morning within a particular window of time, and with a particular number of occupants. Other work schedules, e.g. night or swing-shift, would similarly have an associated substantially regular schedule. On non-work days, e.g. Saturday and Sunday, the destinations 114 are likely to be less predictable, but over time, a recognizable set of driving patterns are likely to emerge to and from various destinations 114, and with various numbers of occupants. The associated destination circles 116 would typically include shopping centers and business districts. The negative affect of infrequent, random stops, e.g. to obtain fuel or stop at a store, can be mitigated if these occur during periods of travel on stored energy. Accordingly, the route computer system 48 can provide for travel using stored energy in areas for which there are likely to be unpredictable or randomly occurring stops.

When the location of origination is a destination 114 corresponding to the driver's work location, the most likely destinations 114 therefrom would be the driver's home if departing at the end of the regular work day. During lunchtime, there would be associated destination circles 116—having an associated margin of error—for restaurant venues, and return to work therefrom after lunch would be highly predicable. A trip to an airport is likely to involve a unique route that is recognizable, particularly towards the end of the trip when near the airport. The negative affect of infrequent, random stops, e.g. to obtain fuel or stop at a store, can be mitigated if these occur during periods of travel on stored energy. Accordingly, the route computer system 48 can provide for travel using stored energy in areas for which there are likely to be unplanned stops.

When the location of origination is a destination 114 corresponding to an airport, the most likely destinations therefrom would be the driver's home if during evening hours (after work) or weekends, or possibly the driver's work location if arrival at the destination 114 would likely be during normal business hours, e.g. if departing from the airport during the morning of a typical business day. If the destination 114 being driven to is an airport, e.g. from either “work” or “home”, the driving pattern would normally be atypical, but over a recognizable driving pattern, and typically during morning or evening hours.

On holidays, regular holiday destinations and returns to the driver's home are often repeatable, even if they occur only seldom. The data structure 144 of FIG. 9 can be expanded to incorporate calendar and holiday information so as to improve the recognition of these associated driving patterns.

If the location of origination is an unknown destination 114, or if the destination 114 to which the vehicle 14 is being driven is unknown, then the route computer system 48 would use a default control mode for which the state of charge of the energy storage device 22 is maintained within tighter limits of a nominal state of charge than would necessarily be the case if the destination 114 and corresponding driving pattern were known and predictable. On relatively long highway trips across the country or state outside the scope of normal driving patterns, the route computer system 48 would typically only utilize GPS and road topography for energy management, and the energy management system 10 would not be expected to provide substantial improvements in overall energy efficiency because a substantial amount of the power is generated by the power generator 16 running at relatively high power levels for which the corresponding efficiency is already relatively high.

The route computer system 48 can adapt to traffic jam situations by not recording the associated stops as destinations. A GPS vehicle location sensor 42 can provide location estimates within +50 feet, so that stops within the roadway of a recognized road 108 can be discriminated from valid destinations 114, for which the vehicle would typically be pulled off the road, e.g. into a driveway or parking lot.

The route computer system 48 can be adapted to provide for ignoring, or pruning from the associated database, destinations 114 associated with relatively infrequent stops, particularly if the size of the associated data base becomes excessively voluminous. For example, destinations 114 occurring less than a threshold percentage of time, e.g. 10 percent, could be ignored or pruned from the database. Alternately, the route computer system 48 could be adapted so as to require a threshold number of occurrences of a particular destination 114, before that destination 114 is activated for route processing.

The designations of “home”, “work”, “airport” or other significant places that are destinations 114 can be programmed into the route computer system 48 by the operator 60 using the operator interface 62. Furthermore, the route computer system 48 could provide for entering different information, and learning different driving patterns, for different operators 60. The route computer system 48 could also provide for the operator 60 to reset the learned information when the vehicle 14 is sold, so that new the driving patterns and destinations 114 of the new driver, drivers 60.1 or operators 60 of the vehicle 14 can be learned.

Following step (1202), in step (1204), if the power generator 16 is not operating, and, if from step (1206), the state of charge (SOC) or amount of stored energy in the energy storage device 22, e.g. battery 22.1, is sufficient to reach the most likely destination 114 or most likely destinations 114 with the limits on the minimum amount of stored energy to maintain in the energy storage device 22, then, in step (1208), the vehicle 14 continues the trip on stored energy from the energy storage device 22. Otherwise, from step (1206), if, in step (1210), the state of charge or amount of stored energy in the energy storage device 22 is less than a threshold SOC Limit, then, in step (1212), the power generator 16 is started so as to generate sufficient electric power 27 to continue operating the vehicle 14. The hierarchy of likely destination circles 116 could be adapted so as to always include a pseudo-destination that is only a short distance from the first destination 114.1/point of origination if the amount of stored energy in the energy storage device 22 is sufficient to reach this pseudo-destination, so as to prevent unnecessarily starting the power generator 16 if the vehicle 14 is simply being repositioned, or returns to the first destination 114.1 unexpectedly after a short journey. The route computer system 48 commences a route processing process (1300), either after the power generator 16 is started in step (1212), or if, from step (1210), the state of charge is greater than or equal to the threshold SOC Limit.

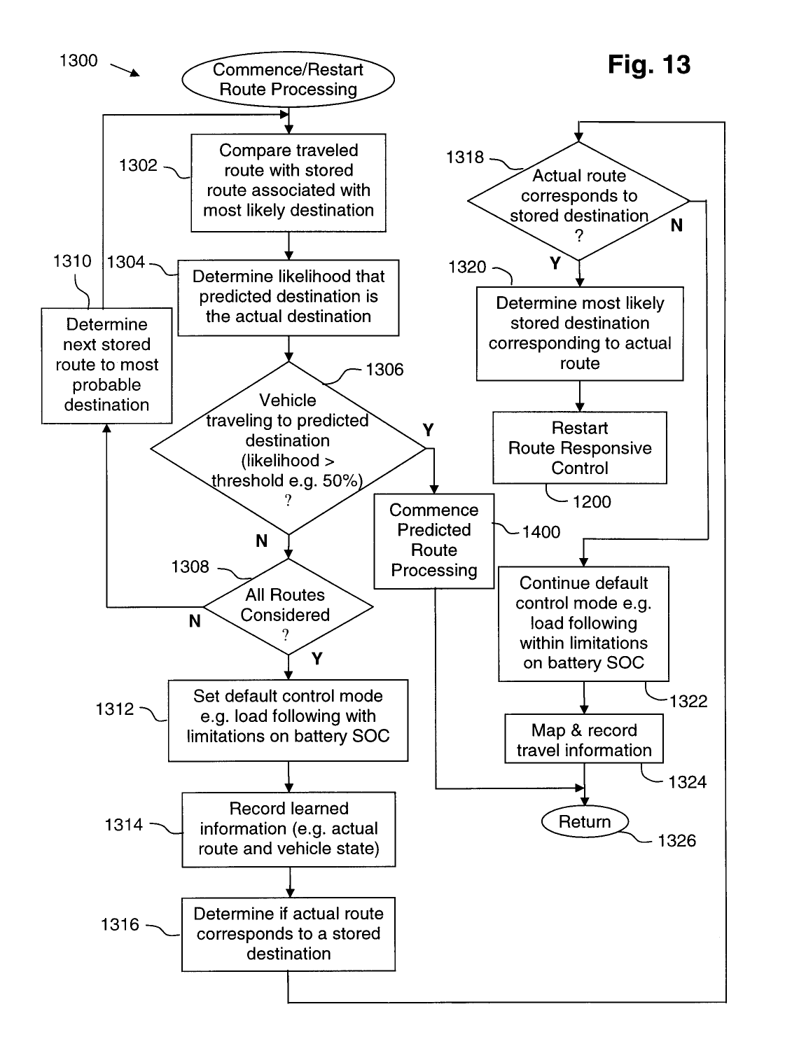

Referring to FIG. 13, the route processing process (1300) commences with step (1302), wherein the actually traveled route is compared with the stored route associated with the most likely destination 114. The stored routes are from previous trips using the same driving pattern for which the associated energy usage of the vehicle 14 is either recorded from estimates of actual usage, or estimated from the associated topography of the roads associated with the driving pattern. Accordingly, this stored route can be referred to as an energy-mapped route. For example, the stored route is recorded in the linked list data structure 146 illustrated in FIG. 10. In step (1304), the route computer system 48 determines the likelihood that the predicted destination is the actual destination, for example, using the information from the data structures 138, 140, 142, 144 and 146 illustrated in FIGS. 8b, 8c, 8d, 9 and 10, subject to the condition that the actual destination 114 must always be reachable from the current location of the vehicle 14. Generally, the route computer system 48 would accumulate over time a database of destinations 114, including the number of occurrences, and would collect associated data for each trip. This database can be used in a variety of ways. For example, simple probability can be used to determine the next destination 114 from any repeatable origin of the vehicle 14; generally predictions of a next destination 114 that are correlated with a particular origin, time and date or day of week tend to be more exact. Correlations that also account for fuel quantity, driver identification, vehicle weight (passengers), holidays, and the road 108 being traveled all improve the accuracy of the predictions. The number of inputs to be considered would depend upon the cost and the desired level of accuracy. Typically, time, date, point of origin, the road 108 being traveled, and the number of times a vehicle 14 has been at an origin/destination 114 would be sufficient for beginning and in-route predictions of destination 114. A variety of techniques can be used for the estimation of a likelihood that the vehicle 14 is traveling to a particular destination 114 or along a particular route, including fuzzy logic, neural networks, or Bayesian inference. The confidence of a particular estimate of a destination 114 or likely associated driving pattern can be improved by confirmation from the operator 60 or driver 60.1, e.g. by aurally or visually querying as to the correctness of a particular determination by the route computer system 48, and receiving either a switch-activated response thereto, or a spoken response thereto which could be automatically detected using a speech recognition system.

If, in step (1306), the likelihood that the vehicle 14 is traveling to a predicted destination is less than a threshold, e.g. 50 percent, then if, in step (1308), there are additional stored routes that lead to the most probable destination 114, then in step (1310), the next stored route is determined and the process repeats with step (1302). Otherwise, from step (1308), in step (1312), the route computer system 48 sets a default control mode for the power generator 16 and electrical power controller 18, for example, load following by the power generator 16 with limitations on the amount of energy stored in the energy storage device 22, e.g. so as to maintain a nominal state of charge of the battery 22.1. Then, in step (1314), the route computer system 48 records the route and energy usage of the vehicle 14, for example, in the data structure 146 of FIG. 10, and in step (1316), the route computer system 48 determines if the actual route either corresponds to a stored driving pattern leading to a stored destination 114, or can lead to a stored destination 114. If, in step (1318), the actual route corresponds to a stored driving pattern leading to a stored destination 114, or can lead to a stored destination 114, then, in step (1320), the route computer system 48 determines the most likely stored destination corresponding to the actual route, after which the route responsive control process (1200) is restarted. Accordingly, the hierarchy of predicted destinations 114 is continuously updated during the operation of the vehicle 14, wherein as vehicle distance and directional changes are accomplished, and possible destinations are eliminated, the predicted destination 114 becomes more and more certain. Otherwise, from step (1318), in step (1322), the default control mode is continued, in step (1324) the route information continues to be recorded, and, in step (1326), the route processing process (1300) returns to the step following the point of invocation, e.g. to step (1214) of the route responsive control process (1200), as is described more fully hereinbelow.

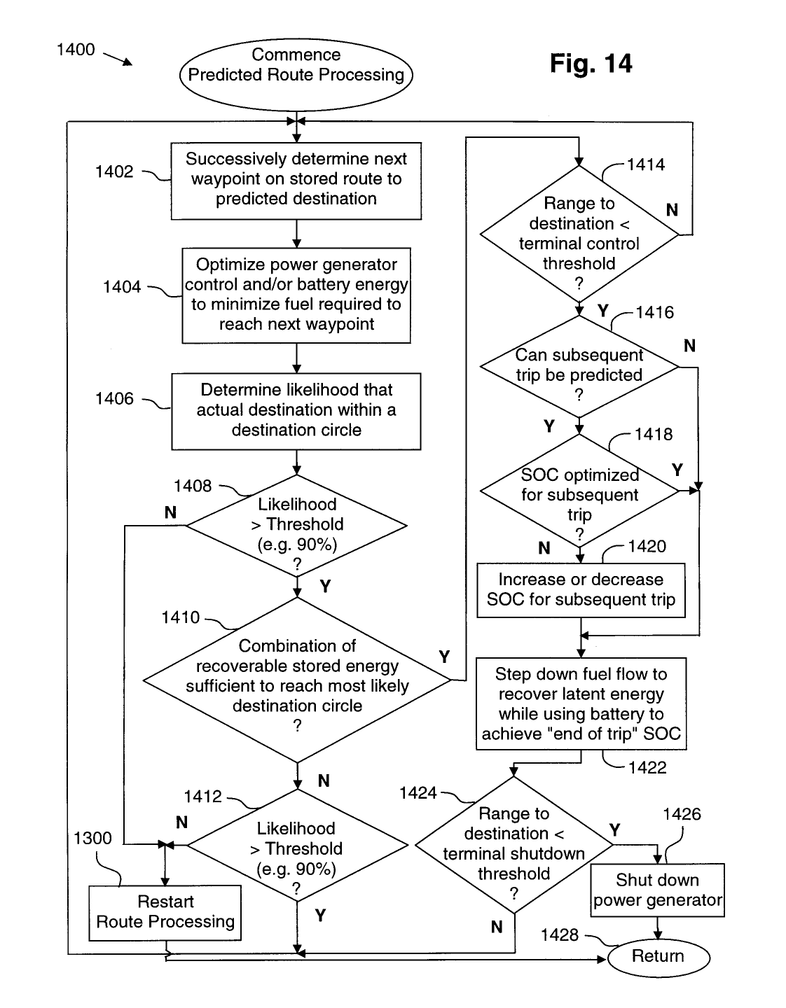

If, in step (1306), the likelihood that the vehicle 14 is traveling to a predicted destination is greater than or equal to the threshold, e.g. 50 percent, then, referring to FIG. 14, the predicted route processing process (1400) commences with step (1402), wherein the route computer system 48 successively determines the next waypoint—e.g. either a node 112 of the road 108, an intersection 110, or a destination 114—on the stored route to the predicted destination 114, for example, using the linked list data structure 146 of FIG. 10. In step (1404), the control of the power generator 16 and energy storage device 22, e.g. battery 22.1, are optimized, e.g. so as to minimize the amount of fuel 28 required to reach the next way point or to reach the predicted destination 114, possibly subject to constraints on the amount of energy stored in the energy storage device 22 upon reaching the predicted destination 114, by sharing the energy resources of the energy storage device 22, power generator 16, vehicle inertia and regenerative braking. Start/stop, low speed and low load requirements would typically make maximum use of the energy storage device 22 e.g. battery 22.1, for electric power 27 to drive the traction motor 20. For example, with a recuperated turbine engine 64 as the power generator 16, the fuel 28 and an associated recuperator 68 could be controlled. Generally, the route computer system 48 continuously updates calculated energy requirements to travel the oncoming segment of the road 108. In step (1406), the route computer system 48 determines the likelihood that the actual destination is within a destination circle 116, and then if, in step (1408), this likelihood exceeds a relatively high threshold, e.g. 90 percent, then, in step (1410), route computer system 48 determines if the combination of recoverable stored energy—e.g. the combination of the state of charge of a battery 22.1 and the heat recovery potential from the recuperator 68 of a recuperated turbine engine 64 power generator 16, or power from regenerative braking—is sufficient for the vehicle 14 to reach the most likely destination circle 116. If not, but if, in step (1412), the likelihood of the actual destination being within a destination circle 116 is greater than the relatively high threshold, e.g. 90 percent, then the process repeats with step (1402). Otherwise, from either step (1408) or step (1412), if the likelihood of the actual destination 114 being within a destination circle 116 is less than or equal to the relatively high threshold, e.g. 90 percent, then the route processing process (1300) is restarted.

From step (1410), if the combination of recoverable stored energy is sufficient for the vehicle 14 to reach the most likely destination circle 116, and if, in step (1414), the range to the predicted destination is not less than a terminal control threshold, then the predicted route processing process (1400) repeats with step (1402). Otherwise, from step (1414), if, in step (1416), the subsequent trip can be predicted, and if, in step (1418), the state of charge of the energy storage device 22 is not optimized for the subsequent trip, then, in step (1420), the state of charge of the energy storage device 22 is either increased or decreased so as to approach an optimal condition for the subsequent trip.

Typical drive times, distances, energy use, etc. can be used in longer term energy prediction needs. For example, predictions of energy use for at least the next day's first trip can permit the end of day state of charge of the energy storage device 22 to be less than a constant standard in order to preclude starting the power generator 16, or to more efficiently run the power generator 16 during the subsequent trip. If the subsequent trip is predicted to be relatively short, it would be beneficial to charge the energy storage device 22, e.g. battery 22.1, during periods of high efficiency during the existing (preceding) trip and perhaps allow the subsequent trip to be entirely completed on stored power. This combination decreases efficiency on the existing trip while minimizing, or eliminating fuel consumption on the subsequent trip, thereby providing for an overall reduction in fuel consumption. Conversely, if the subsequent trip is predicted to be relatively long, the existing (preceding) trip may have an opportunity to more efficiently recover heat energy while allowing the state of charge of the energy storage device 22 to decrease to a level lower than might otherwise be allowed. The use of energy from the energy storage device 22—resulting in an end of trip lower state of charge thereof—possibly in combination with heat recovery, e.g. from a recuperated turbine engine 64, to power the vehicle 14, provides for more efficient storage and use of excess electric power 27 generated by the power generator 16/electric generator or alternator 26 and by regenerative braking. This combination maximizes fuel efficiency on the existing trip while providing for greater operational efficiency on the subsequent trip.

From step (1420), or otherwise, from either step (1416) or step (1418)—i.e. if either the subsequent trip cannot be predicted or the state of charge of the energy storage device 22 is optimized—in step (1422), the power generator 16 is controlled to recover latent energy and the energy storage device 22 is controlled so as to achieve a desirable state of charge thereof at the end of the trip. For example, for a recuperated turbine engine 64 power generator 16, the flow of fuel 28 is tapered down so as to provide for recovering engine heat, including heat from the recuperator 68. The fuel step-down rate will be a function of remaining energy requirements to reach the destination 114 using the power generator 16/electric generator or alternator 26 to drive the traction motor 20 and the need/capability of the energy storage device 22, e.g. battery 22.1, to accept more charge. Then, in step (1424), if the range to the destination is less than a terminal shutdown threshold, in step (1426), the power generator 16 is shut down, i.e. the fuel 28 is cut off, and, in step (1428), the predicted route processing process (1400) returns to the step following its point of invocation, e.g. to step (1326) of the route processing process (1300), from which the route processing process (1300) would return to step (1214) of the route responsive control process (1200).

Referring again to FIG. 12, either upon return to the route responsive control process (1200) from step (1326) of the route processing process (1300)—e.g. upon return from step (1428) of the predicted route processing process (1400)—or following step (1208), if, in step (1214), the destination 114 has been reached within a margin or error, and/or the vehicle is paced in park, then in step (1216) the associated route data for the trip is stored in the associated data structures 138, 140, 142, 144 and 146 illustrated in FIGS. 8b, 8c, 8d, 9 and 10 respectively. The route computer system 48 can also be adapted to announce the destination 114 to the operator 60 via the operator interface 62, e.g. using the Text or A/V Description data from the data structure 134 of FIG. 7d, and possibly to query the operator 60 to verify if this information is correct, or to request information about the destination 114 if this is a new destination 114. If, in step (1218), the power generator 16 is operating, then, in step (1220), the power generator 16 is controlled so as to recover latent energy to the energy storage device 22, e.g. battery 22.1, without shutting off the power generator 16. For example, if the power generator 16 is a recuperated turbine engine 64, then the flow of fuel 28 is tapered down so as to transfer heat energy stored in the recuperator 68 into useful energy, e.g. electrical energy, in the energy storage device 22. Then, in step (1222), if the vehicle ignition key is turned off, then, in step (1224), the fuel 28 is shut off to the power generator 16, and remaining recoverable latent energy is recovered to the energy storage device 22 with the power generator 16 off. For example, a recuperated turbine engine 64 can continue to run strictly from the heat energy of the recuperator 68 without additional fuel 28, thereby continuing to generate shaft power 23 that is converted to electrical power 27 by the electric generator or alternator 26, which is then used to charge the energy storage device 22. Following step (1224), the energy management control process (1100) is terminated in step (1226). Otherwise, from either step (1214) or step (1222), the route responsive control process (1200) is repeated, beginning with step (1202).

Generally, an optimized energy management system 10 would consider the affect of parasitic vehicle loads and losses that are independent of engine operation, such as aerodynamic losses or friction, some of which are intrinsic to the vehicle, and some of which can depend upon external factors such as weather or road conditions. Excess power from the power generator 16 or from regenerative braking can be used to charge the energy storage device 22, and a discharge of stored energy from energy storage device 22 can be used as the sole source of electric power 27 under conditions when the power generator 16 might be otherwise operating at idle or substantially under capacity. The route computer system 48 regularly updates the predicted energy requirements of the vehicle 14 that would be necessary to reach an expected destination or destinations 114 associated with a particular driving pattern. In addition to the baseline topography, these energy requirements can account for ambient conditions, e.g. temperature, pressure, wind velocity and direction, and precipitation; the weight of the vehicle 14; the energy (BTU) content of the fuel 28; the quantity of fuel 28 available; tire pressure, and etc. As the number or trips or the travel distance on the same road are accumulated over time, the route computer system 48 can optimize the control of the hybrid vehicle system 12 to compensate for the affect of other external factors such as traffic flow, or lack thereof during rush hour traffic, which may be anticipated, and responsive to which the route computer system 48 can determine the best use of the total available energy stored in the vehicle 14, i.e. whether it is better to charge the energy storage device 22, e.g. battery 22.1, or to shut off the power generator 16 so as to conserve fuel 28. For some trips, the power generator 16 would not be run at all, but instead, the vehicle 14 would be run entirely from electric power 27 from the energy storage device 22 which would have been pre-charged by either the power generator 16 running the electric generator or alternator 26 in anticipation thereof during a previous trip, or by electric power 27 from a stationary electrical power source 54. Unless the state of charge of the energy storage device 22 were very low, the energy management system 10 would typically not operate the power generator 16 at the beginning of a trip, but instead would first determine the a predicted destination 114 if possible, and not start the power generator 16 until either necessary or desirable in association with a likely driving pattern associated with the predicted destination 114. The power generator 16 would be necessary for load following if the destination 114 cannot be predicted, or if the state of charge of the energy storage device 22, e.g. battery 22.1, is less than or equal to a minimum threshold. Knowledge of the predicted destination 114 provides for conserving fuel and decreasing emissions from the power generator 16 in a hybrid vehicle system 12 with a vehicle location sensor 42 by enabling the power generator 16 to shut down in advance of reaching the predicted destination. Furthermore, for a power generator 16 such as a recuperated turbine engine 64 from which latent heat can be transformed to useful power, the combination of heat recovery after shutdown of the power generator 16 and/or more efficient energy generation during operation of the power generator 16 in the seconds and minutes prior to reaching a predicted destination 114 provides a fuel savings.

The energy management system 10 can provide for reduced fuel consumption by shutting off the power generator 16 and running on stored energy form the energy storage device 22 during periods of relatively low to negative power demands by the vehicle 14, and by operating the power generator 16 at relatively high efficiency—typically with relatively high power output—during periods when power is required from the power generator 16, and using excess power that may be generated by the power generator 16 under these conditions to charge the energy storage device 22. For example, in the first segment of 1369 seconds of the Federal Test Procedure (FTP) used to evaluate vehicle fuel economy and emissions performance, i.e. the city cycle, 565 seconds are spent at zero or negative power, when a conventional engine power generator would otherwise be operating at idle fuel flow in a non-hybrid vehicle system—at zero percent fuel efficiency. Under the same conditions for a hybrid vehicle system 12, the power generator 16 might not be operated at all, or might be operated at relatively high efficiency to generate power that is otherwise used to charge the energy storage device 22. The energy management system 10 can provide for reduced emissions from a power generator 16, e.g. prime mover 16′, by reducing the number of starts thereof, e.g. by providing for operation over some driving patterns using only the energy storage device 22 as a source of power; and by operating the power generator 16 under conditions of relatively high efficiency for which the controls are optimized to reduce fuel consumption subject to constraints on emissions.

For example, once the route computer system 48 determines a likely route of the vehicle 14 for a particular trip, then the associated control schedule governing the operation of the power generator 16 and energy storage device 22 can be optimized in advance of the remainder of the trip, with advanced knowledge of the forthcoming requirements of the likely route, so as to account for topography of and distance along the roads 108 on the expected route, and the expected driving speeds thereon, thereby providing for a global optimization of controls that account for both the overall driving cycle and the particular operating condition at a given time, rather than merely the particular operating condition at any given time. Stated in another way, without advanced knowledge of the route, the control laws of the power generator 16 and energy storage device 22 would be limited to functions of current measurables, e.g. driver accelerator pedal demand, battery 22.1 state of charge, and power generator 16 operating conditions, e.g. operating speed and a measure of load, e.g. mass air flow or manifold absolute pressure. With advanced knowledge of the route, however, the control laws of the power generator 16 and energy storage device 22 can be also be expressed in terms of route dependent variables, such as distance along the route, so as to account for anticipated variations in elevation, anticipated changes in velocity, or anticipated stops at intersections. Furthermore, a control schedule that accounts for the particulars of a particular route can account for energy recovery from either regenerative braking; or from a recuperator 68 of a recuperated turbine engine 64 obtained by control of the recuperated turbine engine 64 in advance of reaching a destination.

For example, a baseline exemplary hybrid vehicle system 12 comprising an internal combustion engine 78 and a battery 22.1, operated exclusively with the power generator 16, i.e. without using the battery 22.1 and without regenerative braking, was predicted to have a fuel economy of 37.9 miles per gallon (MPG) over the FTP city cycle. This same exemplary hybrid vehicle system 12 operated with complete advanced knowledge of the driving cycle in advance of commencing the trip, but constrained to operate so that state of charge of the battery 22.1 at the end of the trip is the same as at the beginning, was predicted to be controllable to achieve a corresponding fuel economy of 45.9 MPG, for example, by shutting off the power generator 16 after about 600 seconds, and restarting the power generator 16 at about 1240 seconds. Such a control schedule might normally be referred to as a “cycle beater”, because it is tailored to a particular driving cycle, e.g. the FTP city cycle, but would not necessarily provide for satisfactory results when the vehicle 14 is driven over other driving cycles. However, the energy management system 10 of the instant invention provides for robustly anticipating a particular likely driving schedule associated with a particular driving pattern of the vehicle 14 on a particular day at a particular time, and can be expected to anticipate different driving schedules for different driving patterns that may be associated with different days or times. Accordingly, to the extent that the control schedule can be adapted for improved overall operating efficiency given this advanced knowledge, then the energy management system 10 of the instant invention provides for a robust cycle dependent optimization of associated control schedules.

For example, when the exemplary hybrid vehicle system 12 is operated with load following, with an additional 1 Kilowatt used to charge the energy storage device 22 while the power generator 16 is operating, including during coast down and stopped conditions, this provides for shutting off the power generator 16 at 1270 seconds, and the associated fuel economy was predicted to be 40.4 MPG. When the exemplary hybrid vehicle system 12 is operated with load following, with an additional 2.5 Kilowatt used to charge the energy storage device 22 while the power generator 16 is operating, including during coast down and stopped conditions, this provides for shutting off the power generator 16 at 1108 seconds, and the associated fuel economy was predicted to be 45.0 MPG. When the exemplary hybrid vehicle system 12 is operated with load following, with an additional 6.7 Kilowatt used to charge the energy storage device 22 while the power generator 16 is operating, including during coast-down and stopped conditions, this provides for shutting off the power generator 16 at 790 seconds, and the associated fuel economy was predicted to be 42.4 MPG. When the exemplary hybrid vehicle system 12 is operated with load following, with an additional 10.0 Kilowatt used to charge the energy storage device 22 while the power generator 16 is operating, including during coast down and stopped conditions, this provides for shutting off the power generator 16 at 611 seconds, and the associated fuel economy was predicted to be 42.0 MPG. It is beneficial to operate the power generator 16 during relatively demanding (i.e. energy/power demanding) portions of a particular driving cycle, whether of a present trip or of the next anticipated trip. Accordingly, for the exemplary hybrid vehicle system 12, if the route computer system 48 were to anticipate the FTP city cycle as a particular driving pattern, then the exemplary hybrid vehicle system 12 would be operated with load following, with an additional 2.5 Kilowatt used to charge the energy storage device 22 while the power generator 16 is operating, including during coast down and stopped conditions, so as to provide for shutting off the power generator 16 at 1108 seconds, which provides a fuel economy of 45.0 MPG. Upon commencing the next trip, the hybrid vehicle system 12 would, for example, initially operate from either the battery 22.1 or the power generator 16 until the associated driving pattern could be anticipated, and if so, would then operate in accordance with control schedules that are optimized for the driving pattern associated with that next trip, e.g. by operating the power generator 16 during periods of relatively substantial load demand, during coast down or stopped conditions to store energy in the energy storage device 22 so as to provide for shutting off the power generator 16 in advance of reaching an associated destination 114, in a manner that provides for recovering latent energy therefrom.

It should be noted that whether or not excess power generated by the power generator 16 can be stored by the energy storage device 22 generally depends upon the timing of excess power generation For example, if the state of charge of a battery 22.1 energy storage device 22 is too high, then the battery 22.1 may not be able to receive the additional charge that would be necessary to store all of the associated excess power. Accordingly, in order to avoid otherwise degrading overall system efficiency, the excess power would need to be timed so as to be provided when the battery 22.1 can receive all of the associated charge. If the battery 22.1 were at a relatively low state of charge, then a considerable amount of excess power could be beneficial because the battery could then accept and store the associated charge, consistent with battery design guidelines. Otherwise, if the battery 22.1 were at a relatively high state of charge, then a considerable amount of excess power would generally not be beneficial because some or all of the associated charge could not be stored by the battery 22.1, and the associated excess power would otherwise be wasted.

Energy recovered by regenerative braking would be expected to increase the fuel economy of the exemplary hybrid vehicle system 12 by about 7 MPG from 45 MPG to 52 MPG for the FTP city cycle.

Generally, once a driving pattern becomes anticipated, so as to provide route information such as illustrated in the linked list data structure 146 of FIG. 10, then the associated control schedule for controlling the power generator 16 and the energy storage device 22 can be determined, either from functions or tables that are predetermined using off-line optimization, or determined using on-line optimization over time from one occurrence of a driving pattern to another, using one or more known optimization techniques, e.g. linear programming, non-linear programming, or dynamic programming. For example, the same techniques that have been used to develop “cycle beater” control strategies can be used to determine optimized or quasi-optimized control schedules that are used by the energy management system 10.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. A method of controlling a hybrid electric vehicle, wherein said hybrid vehicle incorporates a recuperated turbine engine, said method comprising controlling a fuel flow to said recuperated turbine engine so as to convert heat energy to useful work, wherein said heat energy is stored in a recuperator of said recuperated turbine engine as a result of operating said recuperated turbine engine, and the operation of controlling said fuel flow is in anticipation of shutting down said recuperated turbine engine.

2. A method of controlling a hybrid electric vehicle as recited in claim 1, wherein said operation of controlling said fuel flow comprises decreasing said fuel flow over time.

3. A method of controlling a hybrid electric vehicle as recited in claim 2, wherein said operation of controlling said fuel flow comprises shutting off said fuel flow while operating said recuperated turbine engine using heat from said recuperator to heat air that is compressed by a compressor of said recuperated turbine engine.

4. A method of controlling a hybrid electric vehicle as recited in claim 3, wherein said recuperated turbine engine is used to charge an energy storage device of said hybrid electric vehicle after said fuel flow is shut off to said recuperated turbine engine.

5. A method of controlling a hybrid electric vehicle as recited in claim 3, wherein said recuperated turbine engine is used to charge an energy storage device of said hybrid electric vehicle after said vehicle is shutdown upon reaching a destination.

6. A method of controlling a hybrid electric vehicle as recited in claim 1, wherein the operation of controlling said fuel flow is in anticipation of said vehicle reaching a destination.

7. A method of controlling a hybrid electric vehicle, wherein said hybrid vehicle incorporates a recuperated turbine engine, said method comprising:
a. monitoring a condition of said recuperated turbine engine;
b. shutting off a fuel flow to said recuperated turbine engine; and
c. resuming said fuel flow to said recuperated turbine engine so as to resume operating said turbine engine, wherein the operation of resuming said fuel flow is initiated prior to a time when said condition would indicate that said recuperated turbine engine would not likely start without requiring a source of energy external to said recuperated turbine engine to rotate a compressor of said recuperated turbine engine.

8. A method of controlling a hybrid electric vehicle as recited in claim 7, wherein said condition comprises a temperature of a gas stream that interacts with said recuperator.

9. A method of controlling a hybrid electric vehicle as recited in claim 7, wherein said condition comprises a rotational speed of said recuperated turbine engine.

10. A method of controlling a hybrid electric vehicle as recited in claim 7, wherein said recuperated turbine engine is installed in a vehicle, and the operation of shutting off a fuel flow to said recuperated turbine engine occurs when said vehicle is in a mode of operation that does not require power from said recuperated turbine engine.

11. A method of controlling a hybrid electric vehicle as recited in claim 7, wherein while said fuel flow is shut off prior to the operation of resuming said fuel flow, shaft power from said recuperated turbine engine is used to generate electrical energy that is stored in an energy storage device of a hybrid electric vehicle.

12. A method of controlling a hybrid electric vehicle, wherein said hybrid vehicle incorporates a power generator, an energy storage device and a traction motor, said method comprising:
a. determining at least one location of the vehicle;
b. determining a measure responsive or related to an amount of energy required for said vehicle to reach a destination, wherein said measure is responsive to said at least one location of said vehicle in relation to said destination;
c. at least reducing the power generated by said power generator responsive to said measure in advance of said vehicle reaching said destination; and
d. continuing travel of said vehicle to said destination using said traction motor powered at least by said energy storage device

13. A method of controlling a hybrid electric vehicle as recited in claim 12, wherein said at least one location of the vehicle is determined with a vehicle location sensor in the vehicle.

14. A method of controlling a hybrid electric vehicle as recited in claim 13, wherein said vehicle location sensor comprises at least one of a GPS navigation system, an inertial navigation system, a dead reckoning navigation system, and a map matching navigation system.

15. A method of controlling a hybrid electric vehicle as recited in claim 12, wherein said destination is automatically determined responsive to a driving pattern of said vehicle inferred from said at least one location in view of information related to previously stored driving pattern for said vehicle.

16. A method of controlling a hybrid electric vehicle as recited in claim 12, wherein said measure is responsive to a distance of said vehicle to said destination along a predicted route to said destination.

17. A method of controlling a hybrid electric vehicle as recited in claim 12, wherein said measure is responsive to an estimate of energy required to reach said destination along a predicted route to said destination.

18. method of controlling a hybrid electric vehicle as recited in claim 12, wherein said measure is responsive to previously stored information corresponding to said at least one location of said vehicle for subsequent travel along a predicted route to said destination.

19. A method of controlling a hybrid electric vehicle as recited in claim 12, wherein said previously stored information is responsive to the energy that had been required during at least one previous trip to reach said destination along a predicted route to said destination.

20. A method of controlling a hybrid electric vehicle as recited in claim 12, wherein said previously stored information is responsive to an average of a plurality of previous trips from said at least one location of said vehicle to said destination along a predicted route to said destination.

21. A method of controlling a hybrid electric vehicle as recited in claim 18, wherein the operation of at least reducing the power generated by said power generator comprises decreasing a fuel flow to said power generator over time.

22. A method of controlling a hybrid electric vehicle as recited in claim 19, wherein the operation of at least reducing the power generated by said power generator comprises shutting off a fuel flow to said power generator.

23. A method of controlling a hybrid electric vehicle as recited in claim 22, further comprising generating power with said power generator after said fuel flow is shut off to said power generator, and using at least a portion of said power generated by said power generator to store energy in said energy storage device.

24. A method of determining a likely destination of a vehicle, comprising:
a. determining at least one location of the vehicle; and
b. determining a likely second destination of said vehicle responsive to said at least one location of said vehicle, wherein said vehicle is possibly traveling from a known first destination to said likely second destination.

25. A method of determining a likely destination of a vehicle as recited in claim 24, wherein said at least one location of the vehicle is determined with a vehicle location sensor in the vehicle.

26. A method of determining a likely destination of a vehicle as recited in claim 25, wherein said vehicle location sensor comprises at least one of a GPS navigation system, an inertial navigation system, a dead reckoning navigation system, and a map matching navigation system.

27. A method of determining a likely destination of a vehicle as recited in claim 24, wherein the operation of determining said likely second destination comprises: storing information about a previous driving pattern of said vehicle; and comparing said plurality of locations with said information characterizing said at least one route that was driven from said first destination to said possible second destination.

28. A method of determining a likely destination of a vehicle as recited in claim 27, wherein said stored information comprises a likelihood that said vehicle at said first destination will travel to said second destination.

29. A method of determining a likely destination of a vehicle as recited in claim wherein said likelihood is calculated from at least one previous driving pattern of said vehicle.

30. A method of determining a likely destination of a vehicle as recited in claim 28, wherein said likelihood is responsive to a measure of time.

31. A method of determining a likely destination of a vehicle as recited in claim 30, wherein said measure of time comprises any or all of a time of day, a day of week, or a day of a year or month.

32. A method of determining a likely destination of a vehicle as recited in claim 27, wherein said stored information comprises information characterizing at least one route that was previously driven from said first destination to a possible second destination.

33. A method of determining a likely destination of a vehicle as recited in claim 32, wherein the operation of determining said likely second destination from said stored information comprises: recording a plurality of locations of said vehicle after departing said first destination; and using said plurality of locations to evaluate said information characterizing said at least one route that was driven from said first destination to said possible second destination.

34. A method of determining a likely destination of a vehicle as recited in claim 27, wherein said stored information comprises information characterizing at least one route that had previously been driven and which leads from said at least one location of said vehicle to a possible second destination.

35. A method of controlling a hybrid electric vehicle, comprising:
a. determining at least one location of the vehicle in advance of or during a first driving pattern of said vehicle, wherein said first driving pattern of said vehicle is associated with said vehicle traveling from a first destination to a likely second destination;
b. anticipating a likely second driving pattern of said vehicle, wherein the operation of anticipating said second driving pattern is responsive to said at least one location or to said first driving pattern of said vehicle, and said second driving pattern of said vehicle is associated with said vehicle traveling from said likely second destination to a likely third destination; and
c. controlling said hybrid electric vehicle during said first driving pattern responsive to the anticipation of said second driving pattern.

36. A method of controlling a hybrid electric vehicle as recited in claim 35, wherein said at least one location of the vehicle is determined with a vehicle location sensor in the vehicle.

37. A method of controlling a hybrid electric vehicle as recited in claim 36, wherein said vehicle location sensor comprises at least one of a GPS navigation system, an inertial navigation system, a dead reckoning navigation system, and a map matching navigation system.

38. ethod of controlling a hybrid electric vehicle as recited in claim 35, wherein the operation of anticipating said likely second driving pattern of said vehicle comprises: anticipating said likely second destination responsive to said at least one location of said vehicle; and anticipating said likely second driving pattern responsive to said first destination, said likely second destination and/or said first driving pattern associated therewith.

39. A method of controlling a hybrid electric vehicle as recited in claim 38, wherein the operation of anticipating said likely second driving pattern comprises: anticipating said likely third destination; and anticipating said likely second driving pattern responsive to said likely second destination and to said likely third destination.

40. A method of controlling a hybrid electric vehicle as recited in claim 39, wherein the operation of anticipating said likely third destination comprises storing information about a previous driving pattern of said vehicle.

41. A method of controlling a hybrid electric vehicle as recited in claim 40, wherein said stored information comprises a likelihood that said vehicle at said first destination will travel first to said second destination and then to said third destination.

42. A method of controlling a hybrid electric vehicle as recited in claim 41, wherein said likelihood is calculated from at least one previous driving pattern of said vehicle.

43. method of controlling a hybrid electric vehicle as recited in claim 41, wherein said likelihood is responsive to a measure of time.

44. A method of controlling a hybrid electric vehicle as recited in claim 43, wherein said measure of time comprises any or all of a time of day, a day of week, or a day of a year or month.

45. A method of controlling a hybrid electric vehicle as recited in claim 41, wherein the operation of anticipating said likely second driving pattern comprises: storing information about a previous driving pattern of said vehicle; and associating said stored information about said previous driving pattern of said vehicle with said stored information comprising said likelihood that said vehicle at said first destination will travel first to said second destination and then to said third destination.

46. A method of controlling a hybrid electric vehicle as recited in claim 35, wherein the operation of controlling said hybrid electric vehicle comprises controlling at least one of a power generator of said hybrid electric vehicle, an energy storage unit of said hybrid electric vehicle, and an electrical power controller of said hybrid electric vehicle.

47. A hybrid electric vehicle, comprising:
a. a power generator;
b. an energy storage device, wherein the hybrid electric vehicle is adapted to provide for selectively using power generated by said power generator to charge said energy storage device with stored energy;
c. a traction motor, wherein said hybrid electric vehicle is adapted to provide for selectively operating said traction motor from power generated by said power generator and/or power from a discharge of said stored energy from said energy storage device;
d. a vehicle location sensor, wherein said vehicle location sensor generates at least one measure of location of said hybrid electric vehicle;
e. a computer adapted to execute a stored program;
f. a memory operatively associated with said computer, wherein said stored program is adapted to record in said memory information related to at least one previous driving pattern of said vehicle based upon corresponding previously generated information from said vehicle location sensor, and said stored program is adapted to evaluate said at least one measure of location in view of said information related to a previous driving pattern of said vehicle.

48. A hybrid electric vehicle as recited in claim 47, wherein said stored program provides for anticipating a likely second destination from a known first destination responsive to evaluating said at least one measure of location in view of said information related to at least one previous driving pattern of said vehicle.

49. A hybrid electric vehicle as recited in claim 48, wherein said stored program provides for controlling said power generator, said energy storage device, and/or a flow of power therebetween responsive to said at least one measure of location in relation to said likely second destination.

50. A hybrid electric vehicle as recited in claim 48, wherein said stored program provides for determining a likely route leading to said likely second destination from at least one location corresponding to said at least one measure of location, responsive to said at least one measure of location, and to said at least one previous driving pattern of said vehicle stored in said memory.

51. A hybrid electric vehicle as recited in claim 50, wherein said stored program provides for controlling said power generator, said energy storage device, and/or a flow of power therebetween responsive to information stored in said memory related to said likely route.

52. A hybrid electric vehicle as recited in claim 48, wherein said stored program provides for anticipating a likely third destination from a known first destination responsive to evaluating said at least one measure of location in view of said information related to at least one previous driving pattern of said vehicle, and said stored program provides for controlling said power generator, said energy storage device, and/or a flow of power therebetween over a route between said first destination and said likely second destination, responsive to information stored in said memory related to a likely route between said likely second destination and said likely third destination.

53. hybrid electric vehicle as recited in claim 48, further comprising at least one environment sensor, wherein said stored program further provides for controlling said power generator, said energy storage device, and/or a flow of power therebetween over a route between said first destination and said likely second destination, responsive to information from said at least one environment sensor.

54. hybrid electric vehicle as recited in claim 47, further comprising a map database operatively associated with said computer, wherein said map database provides information about a system of roads upon which said vehicle is operated, and by which said information related to said at least one previous driving pattern is structured.
